(19) United States
(12) Patent Application Publication
(10) Pub. No.: US 2009/0137717 A1
(43) Pub. Date: May 28, 2009

(54) ENCAPSULATED EPOXY RESIN COMPOSITION AND ELECTRONIC COMPONENT DEVICE

(76) Inventors: Ryoichi Ikezawa, Ibaraki (JP); Hidetaka Yoshizawa, Ibaraki (JP); Seiichi Akagi, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/995,372

(22) PCT Filed: Jul. 13, 2006
(86) PCT No.: PCT/JP2006/313994

§ 371 Date: Jan. 11, 2008

(30) Foreign Application Priority Data
Jul. 13, 2005 (JP) 2005-204290

(51) Int. Cl. C08K 3/22

(52) U.S. Cl. 524/431; 524/436; 524/430; 524/432; 524/433

(57) ABSTRACT

The present invention relates to an encapsulated epoxy resin composition containing an epoxy resin (A), a hardening agent (B), and magnesium hydroxide (C), the magnesium hydroxide (C) comprising magnesium hydroxide particles with its crystal appearance in a hexagonal column shape having two hexagonal top and bottom base faces in parallel with each other and six peripheral prism faces formed between the base faces and having a length in the c-axis direction of 1.5×10⁻⁶ to 6.0×10⁻⁶ m, and provides an encapsulated epoxy resin composition favorable as a sealer for VLSI's that is superior in flame resistance and also in reliability such as moldability, reflow resistance, moisture resistance and high temperature storage characteristics and an electronic component device containing an element sealed with the composition.

### TECHNICAL FIELD

The present invention relates to an encapsulated epoxy resin composition and an electronic component device containing an element sealed with the composition.

### BACKGROUND ART

Resin sealing has been mainly used in the field of element sealing of electronic component devices such as transistor and IC from the points of productivity, cost, and other, and epoxy resin molding materials have been used widely. It is because epoxy resins are well balanced in electrical properties, moisture resistance, heat resistance, mechanical properties, adhesiveness to insert materials, and others. These encapsulated epoxy-resin molding materials are flame proofed mainly with a combination of antimony oxide and a brominated resin such as tetrabromobisphenol A diglycidyl ether.

In the recent move for regulation of halogenated resins including decabrom and antimony compounds for environmental protection, there exist an increasing need for non-nonhalogenated (non-brominated) and non-antimony encapsulated epoxy-resin molding materials. In addition, bromine compounds are known to show an adverse effect on the high-temperature storage stability of plastic-sealed IC's. It is desirable to reduce the amount of brominated resin also from this viewpoint.

There are many proposed flame-proofing methods without use of a brominated resin and antimony oxide, an examples thereof include methods of using flame retardant other than halogen and antimony such as methods of using red phosphorus (see, for example, Japanese Patent Application Laid-Open (JP-A) No. 9-227765), a phosphoric ester compound (see, for example, JP-A No. 9-235449), a phosphazene compound (see, for example, JP-A NO. 8-225714), a metal hydroxide (see, for example, JP-A NO. 9-241483), a metal hydroxide and a metal oxide in combination (see, for example, JP-A No. 9-100337), a cyclopentadienyl compound such as ferrocene (see, for example, JP-A No. 11-269349), or an organic metal compound such as copper acetylacetonate (see, for example, Hiroshi Kato, Functional Material (CMC Publishing), 1 (6), 34 (1991)); methods of increasing the content of filler (see, for example, JP-A No. 7-82343); and methods of using a high-flame-retardancy resin (see, for example, JP-A No. 11-140277); methods of using a surface-treated metal hydroxide (see, for example, JP-A No. 10-338818); and the like.

However, there is a problem of deterioration in moisture resistance when red phosphorus is used as the encapsulated epoxy-resin molding material, problems of deterioration in moldability by plasticization and in moisture resistance when a phosphoric ester or phosphazene compound is used, problems of deterioration in flowability and mold release efficiency when a metal hydroxide is used, or a problem of deterioration in flowability when a metal oxide is used or when the filler content is raised. In addition, there is a problem of inhibition of hardening reaction and thus, deterioration in moldability when an organic metal compound such as copper acetylacetonate is used. Further, in the traditional method of using a high flame-retardancy resin, the electronic component devices obtained could not satisfy the requirements in flame resistance specified by UL-94 V-0 sufficiently. Among many metal hydroxides, magnesium hydroxide is higher in heat resistance, and thus, a possibility of using it favorably in encapsulated epoxy-resin molding materials was suggested. However, magnesium hydroxide demanded addition of a great amount of it for sufficient flame resistance and thus, caused a problem of deterioration in moldability such as flowability, and it was also poor in acid resistance and caused a problem of corrosion and whitening of the surface in the solder-plating step during production of semiconductor devices. These problems could not be overcome even by the surface treatment described above.

In addition, conventional magnesium hydroxide caused aggregation of fine crystals, forming agglomerates of secondary particles having an average diameter of approximately 10 to 100 m. Thus, when added to an epoxy resin molding material, such magnesium hydroxide caused problems such as low dispersion and thus insufficient performance as a flame retardant. For that reason, proposed were a method of producing more dispersible magnesium hydroxide having a particular particle diameter (JP-A No. 63-277510), a method of producing hexagonal-column crystalline magnesium hydroxide in a hydrothermal synthesis step under high temperature and high pressure (JP-A No. 03-170325), a special shaped magnesium hydroxide complex improved in flowability (JP-A No. 11-11945), a polyhedral composite metal hydroxide having a particular particle size distribution (JP-A No. 2000-53876), and a flame retardant of a mineral-derived magnesium hydroxide surface-coated by surface finishing having specific contents of the impurities: iron (Fe) compounds and silicon (Si) compounds, and having a particular average diameter and a particular particle size distribution (JP-A No. 2003-3171), and the like.

However, the magnesium hydroxides above were still insufficient in dispersion and flowability, when blended with an epoxy resin molding material. In addition, the production processes were still unsatisfactory, either because of complexity or high cost and demanded further improvement. In particular, the hexagonal-column magnesium hydroxide particles described in JP-A No. 03-170325 were not flat and did not have uniform thickness, and the polyhedral magnesium hydroxide particles described in JP-A No. 11-11945 were also insufficient in crystal thickness, and thus, both particles were unsatisfactorily lower in flowability.

As described above, it was still not possible to obtain moldability, reliability and flame resistance similar to those of an encapsulated epoxy resin molding material containing a brominated resin and antimony oxide in combination, by these methods of increasing the concentrations of nonhalogen, non-antimony flame retardant and filler and of using a highly flame-retardant resin.

### SUMMARY OF THE INVENTION

An object of the present invention, which was made under the circumstance above, is to provide a nonhalogen and non-antimony encapsulated epoxy composition, containing magnesium hydroxide favorable in flowability, filling ability and dispersion when blended with an epoxy resin composition and resistant to the environment during combustion, that is favorable in flame resistance without deterioration in reliability concerning moldability, reflow resistance, moisture resistance and high temperature storage characteristics, and an electronic component device containing an element sealed therewith.

After intensive studies to solve the problems above by focusing on the crystal shape of the magnesium hydroxide particle, the inventors have found that it was possible to achieve the object with an encapsulated epoxy resin composition containing magnesium hydroxide in the hexagonal column shape that is significantly thicker than conventional crystals, i.e., hexagonal-column magnesium hydroxide sufficiently grown in the c-axis direction, and made the present invention.

The present invention relates to the following (1) to (27).

(1) An encapsulated epoxy resin composition containing an epoxy resin (A), a hardening agent (B), and magnesium hydroxide (C), the magnesium hydroxide (C) comprising magnesium hydroxide particles with its crystal appearance in a hexagonal column shape having two hexagonal top and bottom base faces in parallel with each other and six peripheral prism faces formed between the base faces and having a length in the c-axis direction of 1.5×10⁻⁶ to 6.0×10⁻⁶ m.

(2) The encapsulated epoxy resin composition described in (1) above, wherein the magnesium hydroxide particles include those having a volume of 8.0×10⁻¹⁸ to 600×10⁻¹⁸ m³.

(3) The encapsulated epoxy resin composition described in (1) or (2) above, wherein

the magnesium hydroxide particles include those obtained by hydration of magnesium oxide having a crystallite diameter of 50×10⁻⁹ m or more.

(4) The encapsulated epoxy resin composition described in (1) above, wherein the magnesium hydroxide (C) includes a magnesium hydroxide particle mixture comprising the magnesium hydroxide particles and at least one of magnesium hydroxide particles having a volume of 8.0×10⁻¹⁸ to 600×10⁻¹⁸ m³ and magnesium hydroxide particles obtained by hydration of magnesium oxide having a crystallite diameter of 50×10⁻⁹ m or more.

(5) An encapsulated epoxy resin composition containing an epoxy resin (A), a hardening agent (B), and magnesium hydroxide (C), the magnesium hydroxide (C) comprising magnesium hydroxide particles prepared by a production method including a step of obtaining magnesium oxide powder by pulverizing a magnesium oxide raw material having a crystallite diameter of 50×10⁻⁹ m or more and sieving the resulting powder, a step of adding the powder into an organic acid-containing hot water at 100° C. or lower, a step of allowing hydration reaction of the magnesium oxide under high-shear agitation, and a step of filtering, water-washing, and drying the resulting solid matter.

(6) The encapsulated epoxy resin composition described in any one of (1) to (5) above, wherein the magnesium hydroxide (C) is contained in an amount of 5 to 300 parts by mass with respect to 100 parts by mass of the epoxy resin (A).

(7) The encapsulated epoxy resin composition described in any one of (1) to (6) above, further comprising a metal oxide (D).

(8) The encapsulated epoxy resin composition described in (7) above, wherein the metal oxide (D) is an oxide selected from oxides of typical and transition metal elements.

(9) The encapsulated epoxy resin composition described in (8) above, wherein the metal oxide (D) is at least one compound selected from oxides of zinc, magnesium, copper, iron, molybdenum, tungsten, zirconium, manganese and calcium.

(10) The encapsulated epoxy resin composition described in any one of (1) to (9) above, wherein the epoxy resin (A) include at least one resin of biphenyl-based, bisphenol F-based, stilbene-based, sulfur atom-containing, novolak-based, dicyclopentadiene-based, naphthalene-based, triphenylmethane-based, biphenylene-based and naphthol-aralkyl-based epoxy resins.

(11) The encapsulated epoxy resin composition described in (10) above, wherein the sulfur atom-containing epoxy resin is a compound represented by the following General Formula (I):

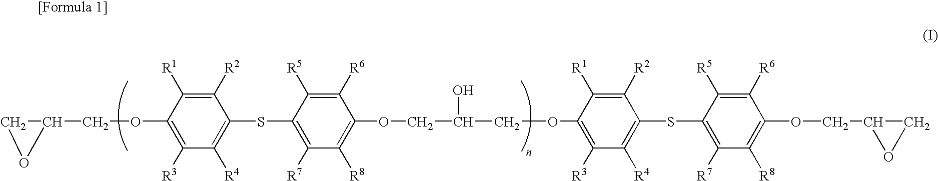

(in Formula (I), R¹ to R⁸ each represent a group selected from a hydrogen atom, substituted or unsubstituted monovalent hydrocarbon groups having 1 to 10 carbon atoms, substituted or unsubstituted alkyl groups having 1 to 10 carbon atoms and substituted or unsubstituted alkoxyl groups having 1 to 10 carbon atoms and may be the same as or different from each other, and n is an integer of 0 to 3).

(12) The encapsulated epoxy resin composition described in any one of (1) to (11) above, wherein the hardening agent (B) includes at least one of biphenyl-based, aralkyl-based, dicyclopentadiene-based, triphenylmethane-based and novolak-based phenol resins.

(13) The encapsulated epoxy resin composition described in any one of (1) to (12) above, further comprising an accelerator (E).

(14) The encapsulated epoxy resin composition described in (13) above, wherein the accelerator (E) includes an adduct of a phosphine compound and a quinone compound.

(15) The encapsulated epoxy resin composition described in (14) above, wherein the accelerator (E) includes an adduct of a phosphine compound having at least one alkyl group bound to the phosphorus atom and a quinone compound.

(16) The encapsulated epoxy resin composition described in any one of (1) to (15) above, further comprising a coupling agent (F).

(17) The encapsulated epoxy resin composition described in (16) above, wherein the coupling agent (F) includes a secondary amino group-containing silane-coupling agent.

(18) The encapsulated epoxy resin composition described in (17) above, wherein the secondary amino group-containing silane-coupling agent includes a compound represented by the following General Formula (II):

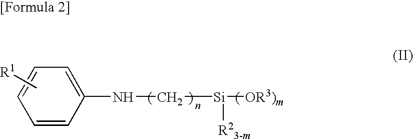

(in Formula (II), R¹ represents a group selected from a hydrogen atom, alkyl groups having 1 to 6 carbon atoms and alkoxyl groups having 1 to 2 carbon atoms; R represents a group selected from alkyl groups having 1 to 6 carbon atoms and a phenyl group; R³ represents a methyl or ethyl group; n is an integer of 1 to 6; and m is an integer of 1 to 3).

(19) The encapsulated epoxy resin composition described in any one of (1) to (18) above, further comprising a compound having a phosphorus atom (G).

(20) The encapsulated epoxy resin composition described in (19) above, wherein the compound having a phosphorus atom (G) includes a phosphoric ester compound.

(21) The encapsulated epoxy resin composition described in (20) above, wherein the phosphoric ester compound includes a compound represented by the following General Formula (III):

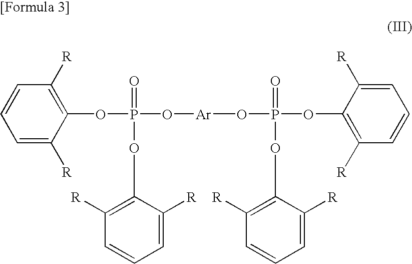

(in Formula (III), eight groups R each represent an alkyl group having 1 to 4 carbon atoms and may be the same as or different from each other; and Ar represents an aromatic ring).

(22) The encapsulated epoxy resin composition described in (19) above, wherein the compound having a phosphorus atom (G) includes phosphine oxide that includes a phosphine compound represented by the following General Formula (IV):

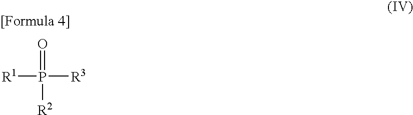

(in General Formula (IV), R¹, R² and R³ each represent a substituted or unsubstituted alkyl, aryl or aralkyl group having 1 to 10 carbon atoms or a hydrogen atom and may be the same as or different from each other; but all of them are not hydrogen atoms).

(23) The encapsulated epoxy resin composition described in any one of (1) to (22) above, further comprising at least one of a linear polyethylene oxide (H) having a weight-average molecular weight of 4,000 or more and a compound (I) of a copolymer of an α-olefin having 5 to 30 carbon atoms and maleic anhydride esterified with a monovalent alcohol having 5 to 25 carbon atoms.

(24) The encapsulated epoxy resin composition described in (23) above, wherein at least one of the components (H) and (I) is premixed with part or all of the component (A).

(25) The encapsulated epoxy resin composition described in any one of (1) to (24) above, further comprising an inorganic filler (J).

(26) The encapsulated epoxy resin composition described in (25) above, wherein the total content of the magnesium hydroxide (C) and the inorganic filler (J) is 60 to 95 mass % with respect to the encapsulated epoxy resin composition.

(27) An electronic component device, comprising an element sealed with the encapsulated epoxy resin composition described in any one of (1) to (26) above.

The disclosure of the present application relates to that of the Japanese Patent Application 2005-204290 filed on Jul. 13, 2005, the disclosure of which is incorporated by reference herein.

### BRIEF DESCRIPTION OF THE DRAWINGS

FIG. 1 is a perspective view showing the crystalline appearance of the magnesium hydroxide particle according to the invention.

### BEST MODE OF CARRYING OUT THE INVENTION

The epoxy resin (A) used in the present invention is not particularly limited, if it is a material commonly used as an encapsulated epoxy-resin molding material, and example thereof include epoxides of novolak resins prepared by condensation or cocondensation of a phenol such as phenol, cresol, xylenol, resorcin, catechol, bisphenol A, or bisphenol F and/or a naphthol such as α-naphthol, β-naphthol, or dihydroxynaphthalene with an aldehyde group-containing compound such as formaldehyde, acetaldehyde, propionaldehyde, benzaldehyde, or salicyl aldehyde in the presence of an acidic catalyst, including phenolic novolak-based epoxy resins, ortho-cresol novolak-based epoxy resins, and triphenylmethane skeleton-containing epoxy resins;

diglycidyl ethers such as bisphenol A, bisphenol F, bisphenol S, and alkyl-substituted or unsubstituted biphenols;

stilbene-based epoxy resins;

hydroquinone-based epoxy resins;

glycidyl ester form epoxy resins prepared in reaction of a polybasic acid such as phthalic acid or dimer acid with epichlorohydrin;

glycidylamine-based epoxy resins prepared in reaction of a polyamine such as diaminodiphenylmethane or isocyanuric acid with epichlorohydrin;

epoxides of a cocondensation resin from dicyclopentadiene and phenol;

epoxy resin containing a naphthalene ring (naphthalene-based epoxy resin);

epoxides of an aralkyl-based phenol resin such as phenol-aralkyl resins and naphthol-aralkyl resins;

biphenylene-based epoxy resins;

trimethylolpropane-based epoxy resins;

terpene modification epoxy resins;

linear aliphatic epoxy resins prepared by oxidation of an olefin bond with a peracid such as peracetic acid;

alicyclic epoxy resins;

sulfur atom-containing epoxy resins; and the like, and these resins may be used alone or in combination of two or more.

Among them, biphenyl-based epoxy resins, bisphenol F-based epoxy resins, stilbene-based epoxy resins and sulfur atom-containing epoxy resins are preferable from the viewpoint of reflow resistance; novolak-based epoxy resins are preferable from the viewpoint of hardening efficiency; dicyclopentadiene-based epoxy resins are preferable from the viewpoint of low hygroscopicity; naphthalene-based epoxy resins and triphenylmethane-based epoxy resins are preferable from the viewpoints of heat resistance and warpage resistance; and biphenylene-based epoxy resins and naphthol-aralkyl-based epoxy resins are preferable from the viewpoints of flame resistance. The encapsulated epoxy-resin molding composition according to the present invention preferably contains at least one of these epoxy resins.

Examples of the biphenyl-based epoxy resins include the epoxy resins represented by the following General Formula (V) and the like; examples of the bisphenol F-based epoxy resins include the epoxy resins represented by the following General Formula (VI) and the like; examples of the stilbene-based epoxy resins include the epoxy resins represented by the following General Formula (VII) and the like; and examples of the sulfur atom-containing epoxy resins include the epoxy resins represented by the following General Formula (I) and the like:

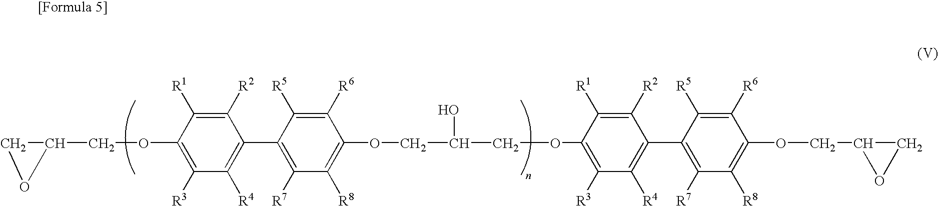

(in Formula (V), R¹ to R⁸ each represent a group selected from a hydrogen atom and substituted or unsubstituted monovalent hydrocarbon groups having 1 to 10 carbon atoms and may be the same as or different from each other; and n is an integer of 0 to 3),

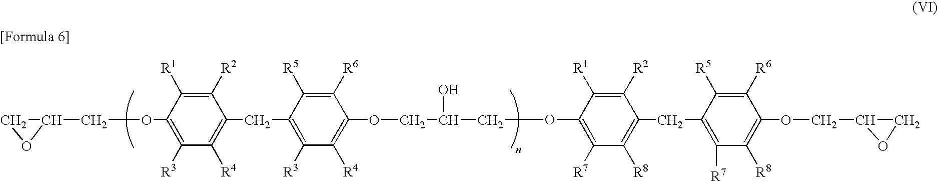

(in Formula (VI), R¹ to R⁸ each represent a group selected from a hydrogen atom, alkyl group having 1 to 10 carbon atoms, alkoxyl groups having 1 to 10 carbon atoms, aryl groups having 6 to 10 carbon atoms, and aralkyl groups having 6 to 10 carbon atoms and may be the same as or different from each other; and n is an integer of 0 to 3),

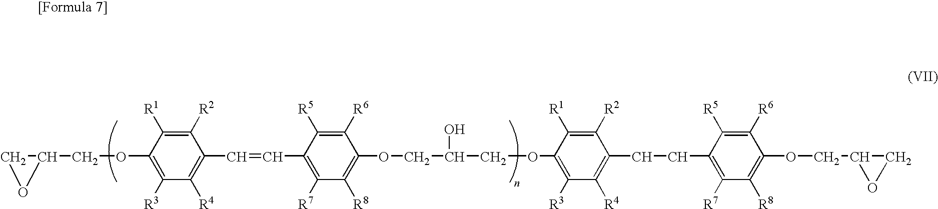

(in Formula (VII), R¹ to R⁸ each represent a group selected from a hydrogen atom and substituted or unsubstituted monovalent hydrocarbon groups having 1 to 5 carbon atoms and may be the same or different from each other; and n is an integer of 0 to 10),

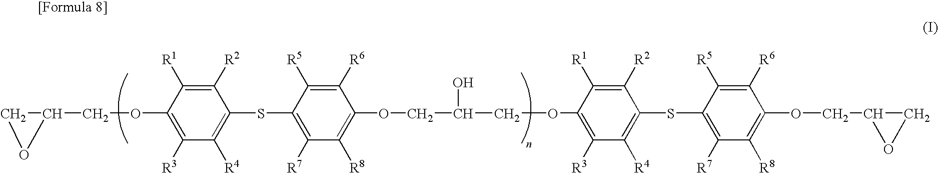

(in Formula (I), R¹ to R⁸ each represent a group selected from a hydrogen atom, substituted or unsubstituted monovalent hydrocarbon groups having 1 to 10 carbon atoms, substituted or unsubstituted alkyl groups having 1 to 10 carbon atoms and substituted or unsubstituted alkoxyl groups having 1 to 10 carbon atoms, and may be the same as or different from each other, and n is an integer of 0 to 3).

Examples of the biphenyl-based epoxy resins represented by General Formula (V) include epoxy resins containing 4,4′-bis(2,3-epoxypropoxy)biphenyl or 4,4′-bis(2,3-epoxypropoxy)-3,3′,5,5′-tetramethylbiphenyl as the principal component; epoxy resins prepared in reaction of epichlorohydrin and 4,4′-biphenol or 4,4′-(3,3′,5,5′-tetramethyl)biphenol; and the like.

Among them, epoxy resins containing 4,4′-bis(2,3-epoxypropoxy)-3,3′,5′5′-tetramethylbiphenyl as the principal component are preferable. Commercially available products thereof include YX-4000 (trade name, manufactured by Japan Epoxy Resin Co., Ltd.) containing the compound wherein n is 0 as the main component and the like.

Commercially available products of the bisphenol F-based epoxy resin represented by General Formula (VI) include, for example, YSLV-80XY (trade name, manufactured by Nippon Steel Chemical Co., Ltd.) wherein R¹, R³, R⁶ and R⁸ are methyl groups, R², R⁴, R⁵ and R⁷ are hydrogen atoms, and n is 0, as the principal component.

The stilbene-based epoxy resin represented by General Formula (VII) can be prepared in reaction of a raw stilbene-based phenol and epichlorohydrin in the presence of a basic substance. Examples of the raw stilbene-based phenols include 3-t-butyl-4,4′-dihydroxy-3′,5,5′-trimethylstilbene, 3-t-butyl-4,4′-dihydroxy-3′,5′,6-trimethylstilbene, 4,4′-dihydroxy-3,3′,5′5′-tetramethylstilbene, 4,4′-dihydroxy-3,3′-di-t-butyl-5,5′-dimethylstilbene, 4,4′-dihydroxy-3,3′-di-t-butyl-6,6′-dimethylstilbene, and the like; and, among them, 3-t-butyl-4,4′-dihydroxy-3′,5,5′-trimethylstilbene and 4,4′-dihydroxy-3,3′,5′5′-tetramethylstilbene are preferable. These stilbene-based phenols may be used alone or in combination of two or more.

Among the sulfur atom-containing epoxy resins represented by General Formula (I), epoxy resins in which R², R³, R⁶ and R⁷ are hydrogen atoms and R¹, R⁴, R⁵ and R⁸ are alkyl groups are preferable; and epoxy resins in which R², R³, R⁶ and R⁷ are hydrogen atoms, R¹ and R⁸ are tert-butyl groups, and R⁴ and R⁵ are methyl groups are more preferable. Commercially available products of such compounds include YSLV-120TE (trade name, manufactured by Nippon Steel Chemical Co., Ltd.) and the like.

These epoxy resins may be used alone or in combination of two or more, but the total blending rate is preferably 20 mass % or more, more preferably 30 mass % or more, and still more preferably 50 mass % or more, with respect to the total amount of the epoxy resin, for making the resin show its favorable properties.

Examples of the novolak epoxy resins include the epoxy resins represented by the following General Formula (VIII) and the like.

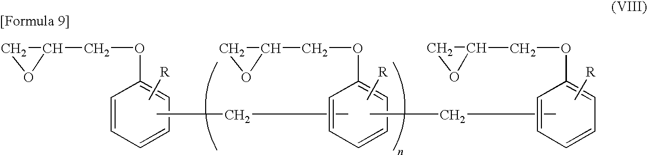

(in Formula (VIII), R is a group selected from a hydrogen atom and substituted or unsubstituted monovalent hydrocarbon groups having 1 to 10 carbon atoms; and n is an integer of 0 to 10).

The novolak epoxy resin represented by General Formula (VIII) can be prepared easily in reaction of a novolak phenol resin with epichlorohydrin. R in General Formula (VIII) is preferably an alkyl group having 1 to 10 carbon atoms such as methyl, ethyl, propyl, butyl, isopropyl, or isobutyl, or an alkoxyl group having 1 to 10 carbon atoms such as methoxy, ethoxy, propoxy, or butoxy, and more preferably a hydrogen atom or a methyl group. n is preferably an integer of 0 to 3. o-Cresol novolak epoxy resins are preferable among the novolak epoxy resins represented by General Formula (VIII). Commercially available products of such compounds include N-600 series products (trade name, manufactured by Dainippon Ink and Chemicals, Inc.) and others.

When a novolak-based epoxy resin is used, the blending rate is preferably 20 mass % or more, more preferably 30 mass % or more with respect to the total amount of the epoxy resin, for making the resin show its favorable properties.

Examples of the dicyclopentadiene-based epoxy resins include the epoxy resins represented by the following General Formula (IX) and the like:

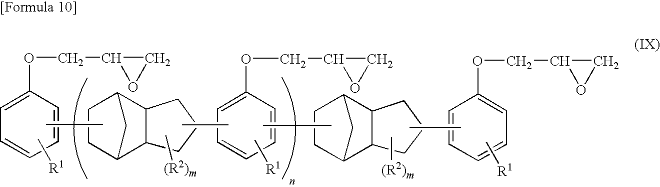

(in Formula (IX), R¹ and R² each independently represent a group selected from a hydrogen atom and substituted or unsubstituted monovalent hydrocarbon groups having 1 to 10 carbon atoms; n is an integer of 0 to 10; and m is an integer of 0 to 6).

Examples of the group R¹ in Formula (IX) include a hydrogen atom; alkyl groups such as methyl, ethyl, propyl, butyl, isopropyl, and tert-butyl; alkenyl groups such as vinyl, allyl, and butenyl; and substituted or unsubstituted monovalent hydrocarbon groups having 1 to 5 carbon atoms such as alkyl halide groups, amino group-substituted alkyl groups, and mercapto group-substituted alkyl groups; among them, alkyl groups such as methyl and ethyl and a hydrogen atom are preferable; and a methyl group and a hydrogen atom are more preferable. Examples of the group R² include a hydrogen atom; alkyl groups such as methyl, ethyl, propyl, butyl, isopropyl, and t-butyl; alkenyl groups such as vinyl, allyl, and butenyl; and substituted or unsubstituted monovalent hydrocarbon group having 1 to 5 carbon atoms such as alkyl halide groups, amino group-substituted alkyl groups, and mercapto group-substituted alkyl groups; and among them, a hydrogen atom is preferable. Commercially available products of such compounds include HP-7200 (trade name, manufactured by Dainippon Ink and Chemicals, Inc.) and the like.

When a dicyclopentadiene-based epoxy resin is used, the blending rate is preferably 20 mass % or more, more preferably 30 mass % or more, with respect to the total amount of the epoxy resin, for making the resin show its favorable properties.

Examples of the naphthalene-based epoxy resins include the epoxy resins represented by the following General Formula (X) and the like; and examples of the triphenylmethane-based epoxy resins include those represented by the following General Formula (XI) and the like:

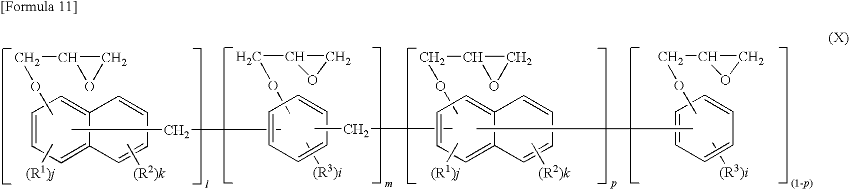

(in Formula (X), R¹ to R³ each represent a group selected from a hydrogen atom and substituted or unsubstituted monovalent hydrocarbon groups having 1 to 12 carbon atoms and may be the same or different from each other; p is 1 or 0; and each of 1 and m is an integer of 0 to 11 satisfying the conditions that (1+m) is an integer of 1 to 11 and (1+p) is an integer of 1 to 12; i is an integer of 0 to 3; j is an integer of 0 to 2; and k is an integer of 0 to 4).

Examples of the naphthalene-based epoxy resins represented by General Formula (X) include random copolymers containing 1 constituent unit and m other constituent units randomly, alternating copolymers containing them alternately, ordered copolymers containing them orderly, and block copolymers containing them blockwise; and these resins may be use alone or in combination of two or more:

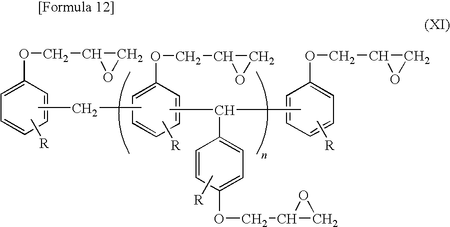

(in Formula (XI), R is a group selected from a hydrogen atom and substituted or unsubstituted monovalent hydrocarbon groups having 1 to 10 carbon atoms; and n is an integer of 1 to 10).

Commercially available products of the triphenylmethane-based epoxy resins represented by General Formula (XI) include, for example, EPPN-500 series products (trade name, manufactured by Nippon Kayaku Co., Ltd.). These epoxy resins may be used alone or in combination of two or more, but the total blending rate is preferably 20 mass % or more, more preferably 30 mass % or more, and still more preferably 50 mass % or more, with respect to the total amount of the epoxy resin, for making the resin show its favorable properties.

The biphenyl-based epoxy resins, bisphenol F-based epoxy resins, stilbene-based epoxy resins, sulfur atom-containing epoxy resins, novolak-based epoxy resins, dicyclopentadiene-based epoxy resins, naphthalene-based epoxy resins and triphenylmethane-based epoxy resins may be used alone or in combination of two or more, but the total blending rate is preferably 50 mass % or more, more preferably 60 mass % or more, and still more preferably 80 mass % or more, with respect to the total amount of the epoxy resin.

Examples of the biphenylene-based epoxy resins include the epoxy resins represented by the following General Formula (XII) and the like; and examples of the naphthol-aralkyl-based epoxy resins include the epoxy resins represented by the following General Formula (XIII) and the like:

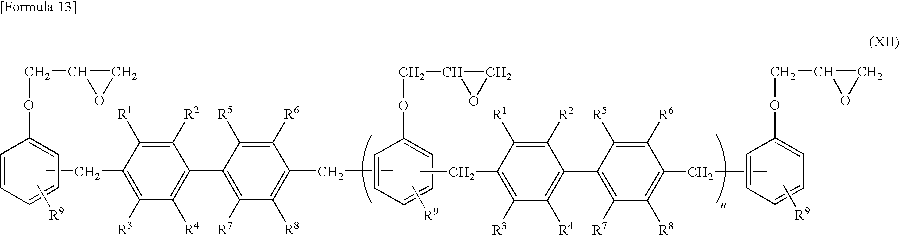

(in Formula (XII), R¹ to R⁹ and may be the same as or different from each other and each represent a group selected from a hydrogen atom; alkyl groups having 1 to 10 carbon atoms such as methyl, ethyl, propyl, butyl, isopropyl, and isobutyl; alkoxyl groups having 1 to 10 carbon atoms such as methoxy, ethoxy, propoxy, and butoxy; aryl group having 6 to 10 carbon atoms such as phenyl, tolyl, and xylyl; and, aralkyl group having 6 to 10 carbon atoms such as benzyl and phenethyl; among them, a hydrogen atom and a methyl group are preferable; and n is an integer of 0 to 10), and

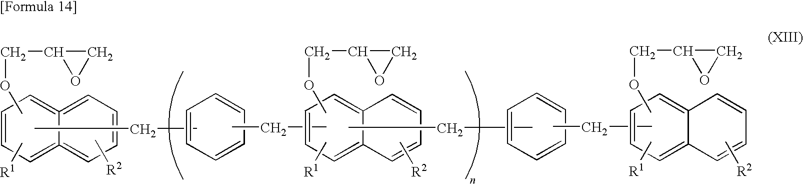

(in Formula (XIII), R¹ to R² each represent a group selected from a hydrogen atom and substituted or unsubstituted monovalent hydrocarbon groups having 1 to 12 carbon atoms and may be the same or different from each other; and n is an integer of 1 to 10).

Commercially available products of the biphenylene-based epoxy resins include NC-3000 (trade name, manufactured by Nippon Kayaku Co., Ltd.). Commercially available products of the naphthol-aralkyl-based epoxy resins include ESN-175 (trade name, manufactured by Tohto Kasei Co., Ltd.) and others. These biphenylene-based epoxy resin and naphthol-aralkyl-based epoxy resin may be used alone or in combination of both of them, but the total blending rate is preferably 20 mass % or more, more preferably 30 mass % or more, and still more preferably 50 mass % or more, with respect to the total amount of the epoxy resin, for making the resin show its favorable properties.

In particular among the epoxy resins above, a sulfur atom-containing epoxy resin having a structure represented by General Formula (I) is most preferable from the viewpoints of reliability such as reflow resistance, moldability, and flame resistance.

The melt viscosity of the epoxy resin (A) according to the present invention at 150° C. is preferably 2 poises or less, more preferably 1 poise or less, and still more preferably 0.5 poise or less, from the viewpoint of flowability. The melt viscosity is a viscosity determined by using an ICI cone plate viscometer.

The hardening agent (B) for use in the present invention is not particularly limited, if it is commonly used in encapsulated epoxy-resin molding materials, and examples thereof include novolak phenol resins prepared in condensation or cocondensation of a phenol such as phenol, cresol, resorcin, catechol, bisphenol A, bisphenol F, phenylphenol, or aminophenol, and/or a naphthol such as α-naphthol, β-naphthol, or dihydroxynaphthalene, with an aldehyde group-containing compound such as formaldehyde, benzaldehyde, or salicylic aldehyde in the presence of an acidic catalyst;

aralkyl-based phenol resins prepared from a phenol and/or a naphthol and dimethoxy-p-xylene or bis(methoxymethyl)biphenyl, such as phenol-aralkyl resins and naphthol-aralkyl resin;

dicyclopentadiene-based phenol resins prepared in copolymerization of a phenol and/or a naphthol and dicyclopentadiene;

naphthol novolak resins;

terpene-modified phenol resins; triphenylmethane-based phenol resins; and the like, and these resins may be used alone or in combination of two or more.

Among them, biphenyl-based phenol resins are preferable from the viewpoints of flame resistance; aralkyl-based phenol resins are preferable from the viewpoints of reflow resistance and hardening efficiency; dicyclopentadiene-based phenol resins are preferable form the viewpoint of low hygroscopicity; triphenylmethane-based phenol resins are preferable from the viewpoints of heat resistance, low expansion coefficient and warping resistance; and novolak-based phenol resins are preferable from the viewpoint of hardening efficiency, and at least one of these phenol resins is preferably contained.

Examples of the biphenyl-based phenol resins include the phenol resins represented by the following General Formula (XIV) and the like:

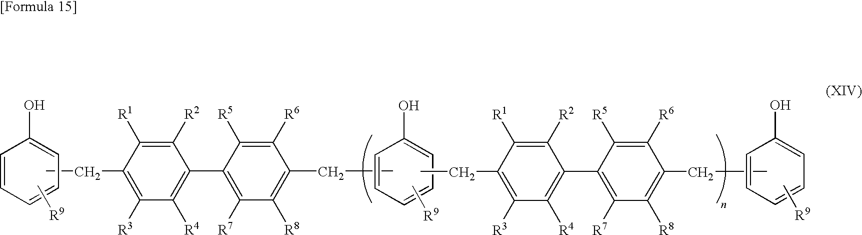

In Formula (XIV), R¹ to R⁹ may be the same as or different from each other, and are selected from a hydrogen atom, alkyl groups having 1 to 10 carbon atoms such as methyl, ethyl, propyl, butyl, isopropyl, and isobutyl, alkoxyl groups having 1 to 10 carbon atoms such as methoxy, ethoxy, propoxy, and butoxy, aryl group having 6 to 10 carbon atoms such as phenyl, tolyl, and xylyl, and aralkyl group having 6 to 10 carbon atoms such as benzyl and phenethyl; and in particular, a hydrogen atom and a methyl group are preferable. n is an integer of 0 to 10.

Examples of the biphenyl-based phenol resins represented by General Formula (XIV) include the compounds wherein all of R¹ to R⁹ are hydrogen atoms, and the like; and among them, a condensate mixture containing a condensate wherein n is 1 or more in an amount of 50 mass % or more is preferable, from the view point of melt viscosity. Commercially available products of the compounds include MEH-7851 (trade name, manufactured by Meiwa Plastic Industries, Ltd.) and the like.

When a biphenyl-based phenol resin is used, the blending rate is preferably 30 mass 6 or more, more preferably 50 mass % or more, and still more preferably 60 mass % or more, with respect to the total amount of the hardening agents for making the resin show its favorable properties.

Examples of the aralkyl-based phenol resins include phenol-aralkyl resins, naphthol-aralkyl resins, and the like, and phenol-aralkyl resins represented by the following General Formula (XV) and the naphthol-aralkyl resin represented by the following General Formula (XVI) are preferable. Phenol-aralkyl resins represented by General Formula (XV) wherein R is a hydrogen atom and n is 0 to 8 on average are more preferable. Specific examples thereof include p-xylylene-based phenol-aralkyl resins, m-xylylene-based phenol-aralkyl resins, and the like. When an aralkyl-based phenol resin is used, the blending rate is preferably 30 mass % or more, more 50 mass % or more, with respect to the total amount of the hardening agents for making the resin show its favorable properties:

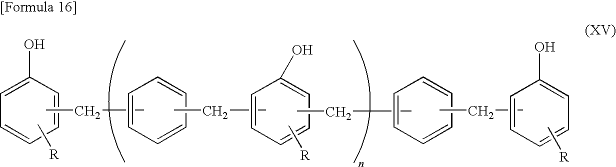

(in Formula (XV), R is selected from a hydrogen atom and substituted or unsubstituted monovalent hydrocarbon groups having 1 to 10 carbon atoms; and n is an integer of 0 to 10).

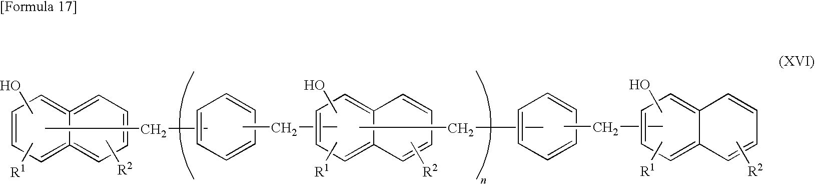

(in Formula (XVI), R¹ to R² each are selected from a hydrogen atom and substituted or unsubstituted monovalent hydrocarbon groups having 1 to 10 carbon atoms and may be the same as or different from each other; and n is an integer of 0 to 10).

Examples of the dicyclopentadiene-based phenol resins include the phenol resins represented by the following General Formula (XVII) and the like:

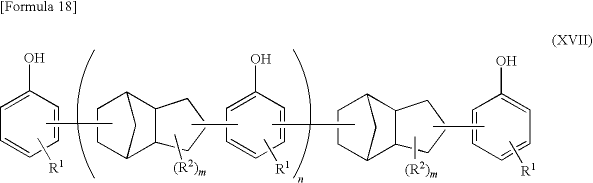

(in Formula (XVII), each of R¹ and R² is selected from a hydrogen atom and substituted or unsubstituted monovalent hydrocarbon groups having 1 to 10 carbon atoms; n is an integer of 0 to 10; and m is an integer of 0 to 6).

When a dicyclopentadiene-based phenol resin is used, the blending rate is preferably 30 mass % or more, more preferably 50 mass % or more, with respect to the total amount of the hardening agents for making the resin show its favorable properties.

Examples of the triphenylmethane-based phenol resins include the phenol resins represented by the following General Formula (XVIII) and the like:

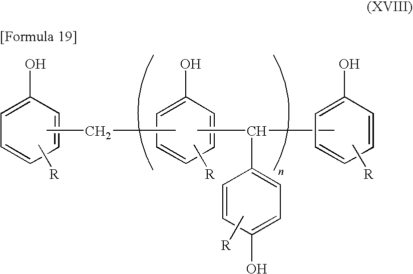

(in Formula (XVIII), R is selected from a hydrogen atom and substituted or unsubstituted monovalent hydrocarbon groups having 1 to 10 carbon atoms; and n is an integer of 1 to 10).

When a triphenylmethane-based phenol resin is used, the blending rate is preferably 30 mass % or more, more preferably 50 mass % or more, with respect to the total amount of the hardening agents for making the resin show its favorable properties.

Examples of the novolak-based phenol resins include phenolic novolak resins, cresol novolak resins, naphthol novolak resins, and the like; and among them, phenolic novolak resins are preferable. When a novolak-based phenol resin is used, the blending rate is 30 mass % or more, more preferably 50 mass % or more, with respect to the total amount of the hardening agents for making the resin show its favorable properties.

The biphenyl-based phenol resins, aralkyl-based phenol resins, dicyclopentadiene-based phenol resins, triphenylmethane-based phenol resins and novolak-based phenol resins may be used alone or in combination of two or more. The total blending rate is preferably 60 mass % or more, more preferably 80 mass % or more, with respect to the total amount of the hardening agents.

The melt viscosity of the hardening agent (B) for use in the present invention at 150° C. is preferably 2 poises or less, more preferably 1 poise or less, from the viewpoint of flowability. The melt viscosity is ICI viscosity.

The equivalence ratio of the epoxy resin (A) to the hardening agent (B), i.e., the ratio in number of the epoxy groups in epoxy resin to the hydroxyl groups in hardening agent (hydroxyl group number in hardening agent/epoxy group number in epoxy resin) is not particularly limited, but is preferably adjusted into the range of 0.5 to 2, more preferably 0.6 to 1.3, for reduction in the amount of the respective unreacted groups. It is more preferably adjusted into the range of 0.8 to 1.2, for obtaining an encapsulated epoxy-resin molding material superior in moldability and reflow resistance.

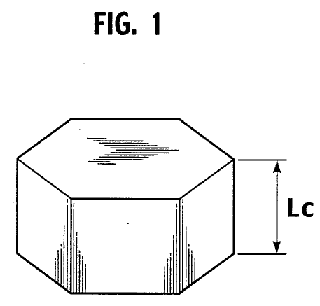

FIG. 1 is a perspective view showing an example of the crystal appearance of the magnesium hydroxide particle contained in the magnesium hydroxide (C) for use in the invention. As shown in FIG. 1, the magnesium hydroxide (C) according to the present invention is characterized by containing magnesium hydroxide particles having a hexagonal column shape and having a length in the c-axis direction (hereinafter, referred to as Lc) in a particular range. Lc is 1.5×10⁻⁶ to 6.0×10⁻⁶ m, and more preferably 1.5×10⁻⁶ to 3.0×10⁻⁶ m. Magnesium hydroxide particles having an Lc of 1.5×10⁻⁶ m or more is higher in filling ability and flowability in epoxy resin compositions. A larger Lc means that the particle in the hexagonal column shape is relatively more grown in the c-axis direction. Such magnesium hydroxide particles are available, for example, as PZ-1, trade name, from Tateho Chemical Industries Co., Ltd. The crystal in the hexagonal column shape has top and bottom hexagonal base faces in parallel with each other and six peripheral prism faces formed between these base faces.

There is some interaction between the magnesium hydroxide particles and the resin, and the particle shape may cause some restriction on free movement of the resin. The tendency is generally influenced by the shape of the particle. Specifically, particles higher in shape anisotropy are more influential. The magnesium hydroxide particle according to the present invention is a particle grown sufficiently in the c-axis direction, and is thus lower in shape anisotropy than conventional particles, causing smaller restriction on the free movement of the resin.

The average particle diameter d of the magnesium hydroxide particle is not particularly limited, but normally, preferably in the range of 0.1×10⁻⁶ to 10×10⁻⁶ m. In the present invention, the length of the magnesium hydroxide particle in the c-axis direction Lc is a value determined by measurement of the particle having the maximum length in the visual field under scanning electron microscope, and the volume V is a value calculated from the length above and also from the length of the hexagonal base of the particle base face. The average particle diameter d of the magnesium hydroxide particles is the 50% diameter of a powder sample, as determined in a distribution analyzer by laser diffraction-scattering method.

The magnesium hydroxide particle according to the invention having an Lc in the particular range above preferably has a volume of 8.0×10⁻¹⁸ to 600×10⁻¹⁸ m³. In addition, the magnesium hydroxide particle according to the present invention is preferably obtained by hydration of magnesium oxide having a crystallite diameter of 50×10⁻⁹ m or more. It is because well-grown magnesium oxide larger in crystallite diameter is resistant to hydration, and thus, prevents generation of fine particles and gives magnesium hydroxide grown significantly in the c-axis direction. The crystallite diameter is a value determined by using an X-ray diffraction method and calculated according to the Scherrer Equation.

More preferably, the magnesium hydroxide (C) for use in the invention contains a magnesium hydroxide particle mixture for improvement in flowability and flame resistance. The magnesium hydroxide particle mixture is a mixture of magnesium hydroxide particles having an Lc in the particular range above with at least one of magnesium hydroxide particles having a volume of 8.0×10⁻¹⁸ to 600×10⁻¹⁸ m³ and magnesium hydroxide particles obtained by hydration of magnesium oxide having a crystallite diameter of 50×10⁻⁹ m or more.

The magnesium hydroxide particle according to the invention is prepared by a production method including

a step of obtaining a MgO powder by pulverizing a magnesium oxide (MgO) raw material having a crystallite diameter of 50×10⁻⁹ m or more and sieving the resulting powder,

a step of adding the sieved MgO powder into hot water containing an added organic acid at 100° C. or lower and then allowing hydration reaction of the MgO under high-shear agitation, and

a step of filtering, washing, and drying the solid matter generated by the reaction.

The organic acid is not particularly limited, but, preferably, a monocarboxylic acid, an oxycarboxylic acid (oxyacid), or the like. Examples of the monocarboxylic acids include formic acid, acetic acid, propionic acid, butyric acid, valeric acid, caproic acid, acrylic acid, crotonic acid, and the like, and examples of the oxycarboxylic acids (oxyacids) include glycolic acid, lactic acid, hydroacrylic acid, α-oxybutyric acid, glyceric acid, salicylic acid, benzoic acid, gallic acid and the like.

In preparation of the magnesium hydroxide particle above, the magnesium oxide (Mgo) used as the raw material is not particularly limited, if it is a powder having a diameter of a particular value or less, obtained by pulverizing magnesium oxide having a crystallite diameter of 50×10⁻⁹ m or more and sieving the resulting powder, but preferably electrolytic MgO obtained by electro melting. Use of the electrolytic MgO allows production of magnesium hydroxide particles having a predetermined diameter only in one hydration reaction. The hydration reaction is carried out in hot water at 100° C. or lower, for example at 50 to 100° C., under high-shear agitation. Specifically, use of a high speed stirrer with a turbine blade for example is preferable. The temperature of the hot water is preferably 60 to 100° C.

The average particle diameter d1 of the magnesium hydroxide particle obtained in the first reaction is preferably 0.5×10⁻⁶ to 1.0×10⁻⁶ m, and it is possible to obtain the larger-diameter magnesium hydroxide particles according to the invention having a predetermined Lc, by using it as the seed crystal in an amount of 30% with respect to the entire magnesium hydroxide in the additional second or latter hydration reaction. It is possible to improve filling ability in resin further, by dry-mixing magnesium hydroxide particles obtained in the early phase having a small diameter with magnesium hydroxide particles having a larger diameter obtained in the latter phase for example in a V-shaped mixer, or by wet-agitating the slurry after hydration in the slurry state.

The magnesium hydroxide particle obtained after hydration reaction above may be subjected to various surface treatments by known methods. For improvement in compatibility to the resin, the surface finishing agent is preferably, for example, a higher fatty acid or the alkali-metal salt thereof, a phosphate ester, a silane-coupling agent, a fatty acid ester of polyvalent alcohol, or the like. Alternatively for improvement for example of acid resistance or water resistance, favorable are surface treatment methods such as alumina coating, metal silicate salt coating by sintering at approximately 500 to 1,000° C. after silica coating, coating with a silicone oil, a polyfluoroalkyl phosphate ester salt, or the like. For example for improvement in ultraviolet ray absorption efficiency, a surface treatment method of coating titanium dioxide by hydrolysis of titanyl sulfate may be used. Alternatively, these surface treatments may be used in combination.

As described in JP-A No. 11-11945 described above, the magnesium hydroxide may be produced as a mixed metal hydroxide, as a zinc compound such as zinc oxide or zinc chloride is added in the process of producing the magnesium hydroxide particle above.

The blending rate of the magnesium hydroxide (C) is preferably 5 to 300 parts by mass with respect to 100 parts by mass of the epoxy resin, more preferably 10 to 200 parts by mass, and still more preferably 20 to 100 parts by mass. A blending rate of less than 5 parts by mass may lead to insufficient flame resistance, while a blending rate of more than 300 parts by mass to deterioration in moldability such as flowability and acid resistance.

A metal oxide (D) may be used in the encapsulated epoxy-resin composition according to the present invention, for improvement in flame resistance. The metal oxide (D) is preferably a metal oxide of a metal selected from metal elements belonging to groups IA, IIA, and IIIA to VIA, so-called typical metal elements, and transition metal elements belonging to groups IIIB to IIB. It is preferably at least one oxide of magnesium, copper, iron, molybdenum, tungsten, zirconium, manganese or calcium from the viewpoints of flame resistance. Metal elements are determined, based on the long periodic table grouping typical elements in subgroup A and transition elements in subgroup B (“Dictionary of Chemistry 4”, reduce-size Ed., 30th, published by Kyoritsu Shuppan Co., Ltd., Feb. 15, 1987).

The blending rate of the metal oxide (D) is preferably 0.1 to 100 mass parts, more preferably 1 to 50 mass parts, and still more preferably 3 to 20 mass parts, with respect to 100 mass parts of the epoxy resin (A). A blending rate of less than 0.1 mass part leads to deterioration in flame-retardant effect, while a blending rate of more than 100 mass parts to deterioration in flowability and hardening efficiency.

An accelerator (E) may be added to the encapsulated epoxy-resin molding composition according to the present an invention as needed for acceleration of the reaction between the epoxy resin (A) and the hardening agent (B). The accelerator (E) is not particularly limited if it is commonly used in encapsulated epoxy-resin molding materials, and examples thereof include cycloamidine compounds such as 1,8-diaza-bicyclo(5,4,0)undecene-7,1,5-diaza-bicyclo(4,3,0)nonene, 5,6-dibutylamino-1,8-diaza-bicyclo(5,4,0)undecene-7, and intramolecular polarized compounds prepared by adding, to the compound above, a π bond-containing compound such as maleic anhydride, a quinone compound such as 1,4-benzoquinone, 2,5-toluquinone, 1,4-naphthoquinone, 2,3-dimethylbenzoquinone, 2,6-dimethylbenzoquinone, 2,3-dimethoxy-5-methyl-1,4-benzoquinone, 2,3-dimethoxy-1,4-benzoquinone, or phenyl-1,4-benzoquinone, or diazo phenylmethane or phenol resin;

tertiary amines such as benzyldimethylamine, triethanolamine, dimethylaminoethanol, and tris(dimethylaminomethyl)phenol and the derivatives thereof;

imidazoles such as 2-methylimidazole, 2-phenylimidazole, 2-phenyl-4-methylimidazole and the derivatives thereof;

phosphine compounds such as tributylphosphine, methyldiphenylphosphine, triphenylphosphine, tris(4-methylphenyl)phosphine, diphenylphosphine, and phenylphosphine and the intramolecular polarized phosphorus compounds prepared by adding, to the phosphine compound above, a π bond-containing compound such as maleic anhydride, the quinone compound above, diazo phenylmethane or phenol resin;

tetraphenylboron salts such as tetraphenylphosphonium tetraphenyl borate, triphenylphosphine tetraphenyl borate, 2-ethyl-4-methylimidazole tetraphenyl borate, and N-methylmorpholine tetraphenyl borate and the derivatives thereof; and the like, and these compounds may be use alone or in combination of two or more. In particular, adducts of a phosphine compound and a quinone compound are preferable.

Among them, triphenylphosphine is preferable from the viewpoints of flame resistance and hardening efficiency; and adducts of a tertiary phosphine compound and a quinone compound are preferable from the viewpoints of flame resistance, hardening efficiency, flowability and release efficiency. Favorable examples of the tertiary phosphine compounds include, but are not limited to, tertiary phosphine compounds having alkyl or aryl groups such as tricyclohexylphosphine, tributylphosphine, dibutylphenylphosphine, butyldiphenylphosphine, ethyldiphenylphosphine, triphenylphosphine, tris(4-methylphenyl)phosphine, tris(4-ethylphenyl)phosphine, tris(4-propylphenyl)phosphine, tris(4-butylphenyl)phosphine, tris(isopropylphenyl)phosphine, tris(tert-butylphenyl)phosphine, tris(2,4-dimethylphenyl)phosphine, tris(2,6-dimethylphenyl)phosphine, tris(2,4,6-trimethylphenyl)phosphine, tris(2,6-dimethyl-4-ethoxyphenyl)phosphine, tris(4-methoxyphenyl)phosphine, tris(4-ethoxyphenyl)phosphine, and the like. Examples of the quinone compounds include o-benzoquinone, p-benzoquinone, diphenoquinone, 1,4-naphthoquinone, anthraquinone, and the like; and among them, p-benzoquinone is preferable from the viewpoints of moisture resistance and storage stability. An adduct of tris(4-methylphenyl)phosphine and p-benzoquinone is more preferable from the viewpoint of release efficiency.

Further, an adduct of a phosphine compound having at least one alkyl group bound to the phosphorus atom and a quinone compound is preferable, from the viewpoints of hardening efficiency, flowability and flame-retardant.

The blending amount of the accelerator is not particularly limited, if it is sufficient for showing a hardening-acceleration effect, but is preferably 0.005 to 2 mass %, more preferably 0.01 to 0.5 mass %, with respect to the encapsulated epoxy-resin molding composition. An amount of less than 0.005 mass % may lead to deterioration in short-term hardening efficiency, while an amount of more than 2 mass % to an excessive high hardening velocity, making it difficult to obtain a favorable molded product.

In the present invention, an inorganic filler (J) may be blended as needed. Addition of an inorganic filler is effective in reducing hygroscopicity and linear expansion coefficient and in increasing heat conductivity and strength, and examples thereof include powders of fused silica, crystalline silica, alumina, zircon, calcium silicate, calcium carbonate, potassium titanate, silicon carbide, silicon nitride, aluminum nitride, boron nitride, beryllia, zirconia, zircon, forsterite, steatite, spinel, mullite, titania, and the like; the spherical beads thereof, glass fiber, and the like. Examples of the flame-retarding inorganic fillers include aluminum hydroxide, zinc borate, zinc molybdate and the like. Commercially available zinc borate products include FB-290 and FB-500 (manufactured by U.S. Borax), FRZ-500C (manufactured by Mizusawa Industrial Chemicals, Ltd.), and the like; and those of zinc molybdenate include KEMGARD 911B, 911C, and 1100 (manufactured by Sherwin-Williams) and the like.

These inorganic fillers may be used alone or in combination of two or more. Among them, fused silica is preferable from the viewpoint of filling ability and low linear expansion coefficient; alumina is preferable from the point of high heat conductivity; and the inorganic filler is preferably spherical in shape from the points of filling ability and abrasion to mold.

The amount of the inorganic filler blended, together with magnesium hydroxide (C), is preferably 50 mass % or more, more preferably 60 to 95 mass %, and still more preferably 70 to 90 mass %, with respect to the encapsulated epoxy-resin molding composition, from the viewpoints of flame resistance, moldability, hygroscopicity, linear expansion coefficient, strength and reflow resistance. An amount of less than 60 mass % may lead to deterioration in flame resistance and reflow resistance, while an amount of more than 95 mass % to insufficient flowability and also to deterioration in flame resistance.

When an inorganic filler (J) is used, a coupling agent (F) is preferably added to the encapsulated epoxy-resin molding composition according to the present invention, for improvement in adhesiveness between the resin components and the filler.

The coupling agent (F) is not particularly limited if it is commonly used in encapsulated epoxy-resin molding materials, and examples thereof include various silane compounds such as primary, secondary and/or tertiary amino group-containing silane compounds, epoxysilanes, mercaptosilanes, alkylsilanes, ureidosilanes, and vinylsilanes; titanium compounds, aluminum chelates, aluminum/zirconium compounds, and the like.

Specific examples thereof include silane coupling agents such as vinyl trichlorosilane, vinyltriethoxysilane, vinyltris(β-methoxyethoxy)silane, γ-methacryloxypropyltrimethoxysilane, β-(3,4-epoxycyclohexyl)ethyltrimethoxysilane, γ-glycidoxypropyltrimethoxysilane, γ-glycidoxypropylmethyldimethoxysilane, vinyltriacetoxysilane, γ-mercaptopropyltrimethoxysilane, γ-aminopropyltrimethoxysilane, γ-aminopropylmethyldimethoxysilane, γ-aminopropyltriethoxysilane, γ-aminopropylmethyl diethoxysilane, γ-anilinopropyltrimethoxysilane, γ-anilinopropyltriethoxysilane, γ-(N,N-dimethyl)aminopropyltrimethoxysilane, γ-(N,N-diethyl)aminopropyltrimethoxysilane, γ-(N,N-dibutyl)aminopropyltrimethoxysilane, γ-(N-methyl)anilinopropyltrimethoxysilane, γ-(N-ethyl)anilinopropyltrimethoxysilane, γ-(N,N-dimethyl)aminopropyltriethoxysilane, γ-(N,N-diethyl)aminopropyltriethoxysilane, γ-(N,N-dibutyl)aminopropyltriethoxysilane, γ-(N-methyl)anilinopropyltriethoxysilane, γ-(N-ethyl)anilinopropyltriethoxysilane, γ-(N,N-dimethyl)aminopropylmethyldimethoxysilane, γ-(N,N-diethyl)aminopropylmethyldimethoxysilane, γ-(N,N-dibutyl)aminopropylmethyldimethoxysilane, γ-(N-methyl)anilinopropylmethyldimethoxysilane, γ-(N-ethyl)anilinopropylmethyldimethoxysilane, N-(trimethoxysilylpropyl)ethylenediamine, N-(dimethoxymethylsilylisopropyl)ethylenediamine, methyltrimethoxysilane, dimethyldimethoxysilane, methyltriethoxysilane, γ-chloropropyltrimethoxysilane, hexamethyldisilane, vinyltrimethoxysilane, and γ-mercaptopropylmethyldimethoxysilane; titanate coupling agents such as isopropyl triisostearoyl titanate, isopropyl tris(dioctyl pyrophosphate) titanate, isopropyl tri(N-aminoethyl-aminoethyl)titanate, tetraoctyl bis(ditridecylphosphite) titanate, tetra(2,2-diallyloxymethyl-1-butyl)bis(ditridecyl)phosphite titanate, bis(dioctyl pyrophosphate) oxyacetate titanate, bis(dioctylpyrophosphato)ethylene titanate, isopropyl trioctanoyl titanate, isopropyl dimethacryloy isostearoyl titanate, isopropyl tridodecylbenzenesulfonyl titanate, isopropyl isostearoyl diacryl titanate, isopropyl tri(dioctylphosphate) titanate, isopropyl tricumylphenyl titanate, and tetraisopropyl bis(dioctylphosphite) titanate; and the like, and these compounds may be used alone or in combination of two or more.

Among them, silane-coupling agents, particularly secondary amino group-containing silane-coupling agents are preferable from the viewpoints of flowability and flame resistance. The secondary amino group-containing silane-coupling agent is not particularly limited if it is a silane compound having a secondary amino group in the molecule.

Examples thereof include γ-anilinopropyltrimethoxysilane, γ-anilinopropyltriethoxysilane, γ-anilinopropylmethyldimethoxysilane, γ-anilinopropylmethyldiethoxysilane, γ-anilinopropylethyldiethoxysilane, γ-anilinopropylethyldimethoxysilane, γ-anilinomethyltrimethoxysilane, γ-anilinomethyltriethoxysilane, γ-anilinomethylmethyldimethoxysilane, γ-anilinomethylmethyldiethoxysilane, γ-anilinomethylethyldiethoxysilane, γ-anilinomethylethyldimethoxysilane, N-(p-methoxyphenyl)-γ-aminopropyltrimethoxysilane, N-(p-methoxyphenyl)-γ-aminopropyltriethoxysilane, N-(p-methoxyphenyl)-γ-aminopropylmethyldimethoxysilane, N-(p-methoxyphenyl)-γ-aminopropylmethyldiethoxysilane, N-(p-methoxyphenyl)-γ-aminopropylethyldiethoxysilane, N-(p-methoxyphenyl)-γ-aminopropyl-methyldimethoxysilane, γ-(N-methyl)aminopropyltrimethoxysilane, γ-(N-ethyl)aminopropyltrimethoxysilane, γ-(n-butyl)aminopropyltrimethoxysilane, γ-(N-benzyl)aminopropyltrimethoxysilane, γ-(N-methyl)aminopropyltriethoxysilane, γ-(N-ethyl)aminopropyltriethoxysilane, γ-(n-butyl)aminopropyltriethoxysilane, γ-(N-benzyl)aminopropyltriethoxysilane, γ-(N-methyl)aminopropylmethyldimethoxysilane, γ-(N-ethyl)aminopropylmethyldimethoxysilane, γ-(n-butyl)aminopropylmethyldimethoxysilane, γ-(N-benzyl)aminopropylmethyldimethoxysilane, N-β-(aminoethyl)-γ-aminopropyltrimethoxysilane, γ-(β-aminoethyl)aminopropyltrimethoxysilane, N-β-(N-vinylbenzylaminoethyl)-γ-aminopropyltrimethoxysilane and the like. Among them, particularly preferable are the aminosilane-coupling agents represented by the following General Formula (II):

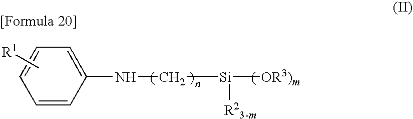

(in Formula (II), R¹ represents a group selected from a hydrogen atom, alkyl groups having 1 to 6 carbon atoms, and alkoxyl group having 1 to 2 carbon atoms; R² represents a group selected from alkyl group having 1 to 6 carbon atoms and a phenyl group; R³ represents a methyl or ethyl group; n is an integer of 1 to 6; and m is an integer of 1 to 3).

The total blending amount of the coupling agents is preferably 0.037 to 5 mass %, more preferably 0.05 to 4.75 mass %, and still more preferably 0.1 to 2.5 mass %, with respect to the encapsulated epoxy-resin molding composition. An amount of less than 0.037 mass % may lead to deterioration in the adhesiveness to frame, while an amount of more than 4.75 mass % to deterioration in package moldability.

A phosphorus atom-containing compound (G) may be blended as needed in the encapsulated epoxy-resin composition according to the present invention for further improvement in flame resistance. The phosphorus atom-containing compound (G) is not particularly limited, as far as the advantageous effects of the present invention is obtained, and examples thereof include coated or uncoated red phosphorus; phosphorus and nitrogen-containing compounds such as cyclophosphazene; phosphonates such as nitrilotrismethylenephosphonic acid tricalcium salt and methane-1-hydroxy-1,1-diphosphonic acid dicalcium salt; phosphine and phosphine oxide compounds such as triphenylphosphine oxide, 2-(diphenylphosphinyl)hydroquinone, and 2,2-[(2-(diphenylphosphinyl)-1,4-phenylene)bis(oxymethylene)]bis-oxirane, and tri-n-octylphosphine oxide; phosphoric ester compounds; and the like, and these compounds may be used alone or in combination of two or more.

The red phosphorus is preferably a coated red phosphorus such as a red phosphorus coated with a thermosetting resin or coated with an inorganic compound and an organic compound.

Examples of the thermosetting resins used for the red phosphorus coated with a thermosetting resin include epoxy resins, phenol resins, melamine resins, urethane resins, cyanate resins, urea-formalin resins, aniline-formalin resins, furan resins, polyamide resins, polyamide-imide resins, polyimide resins, and the like, and these resins may be used alone or in combination of two or more. Red phosphorus may be coated with a thermosetting by coating and polymerizing the monomer or oligomer for the resin simultaneously thereon, or alternatively, the thermosetting resin may be hardened after coating. In particular, epoxy resins, phenol resins and melamine resins are preferable, from the viewpoint of the compatibility with the base resin blended in the encapsulated epoxy-resin molding composition.

Examples of the inorganic compounds used in the red phosphorus coated with an inorganic compound and an organic compound include aluminum hydroxide, magnesium hydroxide, calcium hydroxide, titanium hydroxide, zirconium hydroxide, hydrated zirconium oxide, bismuth hydroxide, barium carbonate, calcium carbonate, zinc oxide, titanium oxide, nickel oxide, iron oxide, and the like, and these compounds may be used alone or in combination of two or more. In particular, zirconium hydroxide, hydrated zirconium oxide, aluminum hydroxide and zinc oxide, which are superior in phosphate ion-trapping efficiency, are preferable.

Examples of the organic compounds used in the red phosphorus coated with an inorganic compound and an organic compound include low-molecular weight compounds such as those used in surface treatment as a coupling agent or a chelating agent, relatively high-molecular weight compounds such as thermoplastic resin and thermosetting resin, and the like; and these compounds may be used alone or in combination of two or more. In particular, thermosetting resins are preferable from the viewpoint of coating efficiency, and epoxy resins, phenol resins and melamine resins are more preferable from the viewpoint of the compatibility with the base resin blended in the encapsulated epoxy-resin molding composition.

When red phosphorus is coated with an inorganic compound and an organic compound, the order of coating is not limited, and the inorganic compound may be coated before the organic compound, the organic compound coated before the inorganic compound, or a mixture thereof may be coated simultaneously. The coating may be by physical adsorption, chemically binding, or others. The inorganic and organic compounds may be present separately, or part or all of them may present as bound to each other after coating.

As for the amounts of the inorganic and organic compounds, the weight ratio of the inorganic compound to the organic compound (inorganic compound/organic compound) is preferably 1/99 to 99/1, more preferably 10/90 to 95/5, and still more preferably 30/70 to 90/10, and the inorganic compound and the organic compounds or the raw monomer or oligomer thereof are preferably so adjusted that the ratio falls in the range above.

A coated red phosphorus such as the red phosphorus coated with a thermosetting resin or the red phosphorus coated with an inorganic compound and an organic compound can be prepared, for example, according to any one of known coating methods such as those described in JP-A Nos. 62-21704 and 52-131695, and others. The thickness of the coated film is not particularly limited, as far as the advantageous effects of the present invention are obtained, and coating may be performed uniformly or unevenly on the surface of red phosphorus.

The particle diameter of red phosphorus is preferably 1 to 100 μm, more preferably 5 to 50 μm, as average diameter (particle diameter at cumulative 50 mass % in particle size distribution). An average diameter of less than 1 μm leads to increase in the phosphate ion concentration in the molding and deterioration in moisture resistance, while an average diameter of more than 100 μm to more frequent troubles such as deformation of wire, short circuiting and disconnection when the material is used in a high-integration and high-density semiconductor having a narrow pad pitch.

Among the phosphorus atom-containing compounds (G) above, phosphoric ester compounds and phosphine oxide are preferable, from the viewpoint of flowability. The phosphoric ester compound is not particularly limited if it is an ester compound from a phosphoric acid and an alcohol or phenol compound, and examples thereof include trimethyl phosphate, triethylphosphate, triphenylphosphate, tricresylphosphate, trixylenyl phosphate, cresyl diphenyl phosphate, xylenyl diphenyl phosphate, tris(2,6-dimethylphenyl)phosphate and aromatic condensed phosphoric esters, and the like. Among them, aromatic condensation phosphoric ester compounds represented by the following General Formula (III) are preferable, from the viewpoint of hydrolysis resistance.

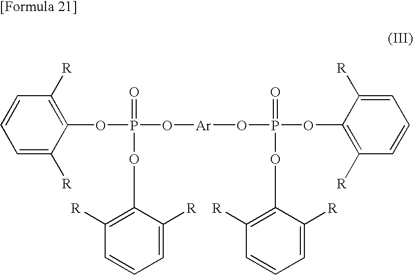

(in General Formula (III), eight groups R each represent an alkyl group having 1 to 4 carbon atoms and may be all the same or different from each other; and Ar represents an aromatic ring).

Examples of the phosphoric ester compounds represented by Formula (III) include the phosphoric esters represented by the following formulae (XX) to (XXIV) and the like:

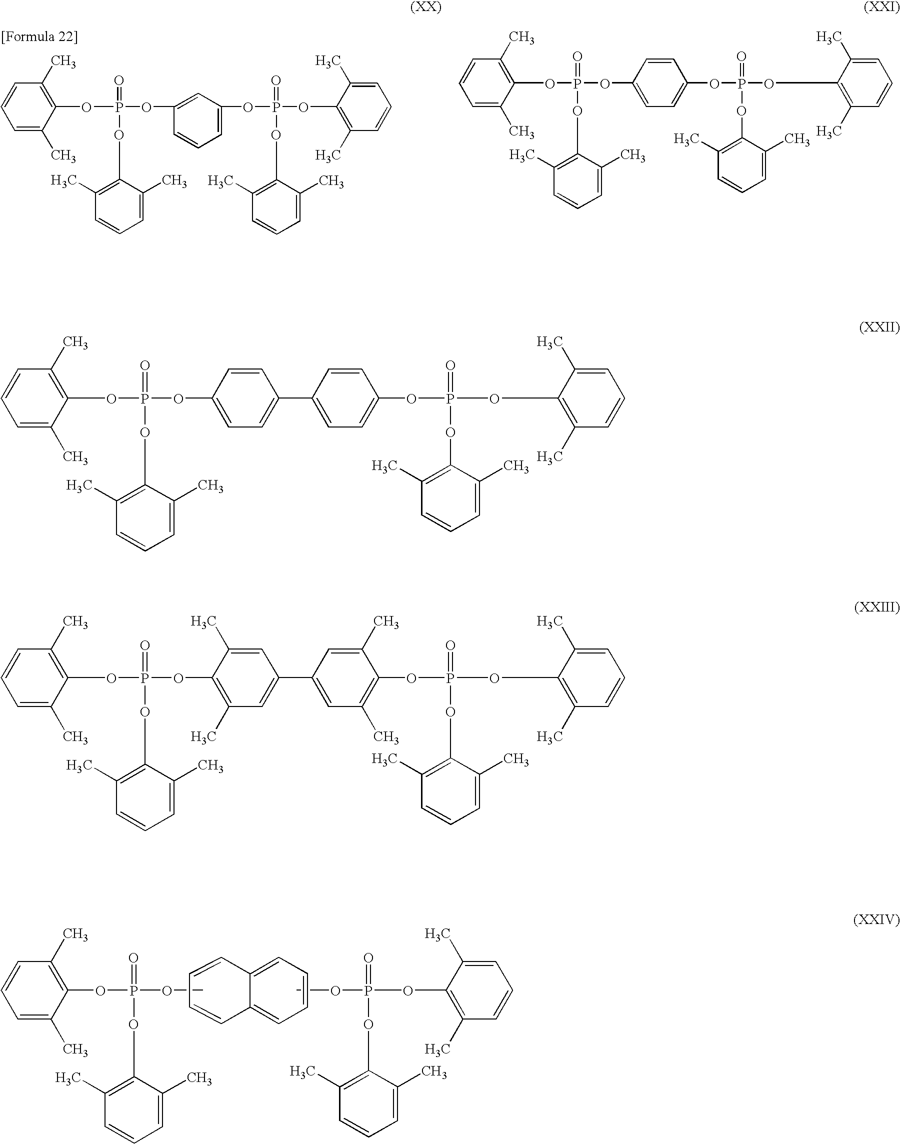

The amount of the phosphoric ester compound added is preferably in the range of 0.2 to 3.0 mass % as phosphorus atom, with respect to all other components excluding the filler. An addition amount of less than 0.2 mass % leads to deterioration in flame-retarding efficiency, while an addition amount of more than 3.0 mass % to deterioration in moldability and moisture resistance and also in deterioration in appearance due to exudation of the phosphoric ester compound during molding.

For use as a flame retardant, the phosphine oxide is preferably a compound represented by the following General Formula (IV):

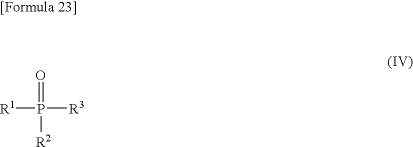

(in Formula (IV), R¹, R² and R³ each represent a substituted or unsubstituted alkyl, aryl, or aralkyl group having 1 to 10 carbon atoms or a hydrogen atom and may be the same as or different from each other; however, all of the groups are not hydrogen atoms at the same time).

Among the phosphorus compounds represented by General Formula (IV), those having substituted or unsubstituted aryl groups as R¹ to R³ are preferable, and those having phenyl groups are particularly preferable, from the viewpoint of hydrolysis resistance.

The amount of the phosphine oxide blended is preferably 0.01 to 0.2 mass % as phosphorus atom, with respect to the encapsulated epoxy-resin molding composition. It is more preferably 0.02 to 0.1 mass % and still more preferably 0.03 to 0.08 mass %. An amount of less than 0.01 mass % may lead to deterioration in flame resistance, while an amount of more than 0.2 mass % to deterioration in moldability and moisture resistance.

Examples of the cyclophosphazenes include cyclic phosphazene compounds having the groups represented by the following Formula (XXV) and/or the following Formula (XXVI) as recurring units in the main chain skeleton, compounds having the groups represented by the following Formula (XXVII) and/or the following Formula (XXVIII) as recurring units different in the substitution site of the phosphorus atoms in the phosphazene ring, and the like:

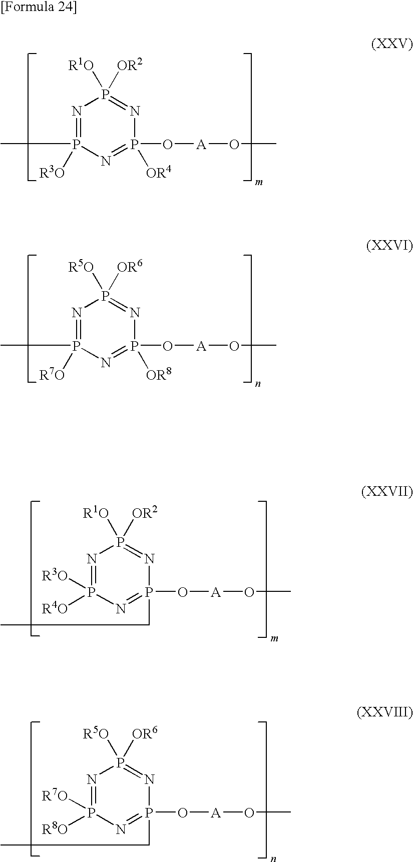

In Formulae (XXV) and (XXVII), m is an integer of 1 to 10; R¹ to R⁴ each represent a group selected from alkyl and aryl groups having 1 to 12 carbon atoms that may be substituted and a hydroxyl group, and may be the same as or different from each other. A represents an alkylene or arylene group having 1 to 4 carbon atoms. In Formulae (XXVI) and (XXVIII), n is an integer of 1 to 10; R⁵ to R⁸ each represent a group selected from alkyl and aryl groups having 1 to 12 carbon atoms that may be substituted, and may be the same as or different from each other; and A represents an alkylene or arylene group having 1 to 4 carbon atoms. Also in the same Formulae, all m groups of R¹, R², R³, and R⁴ may be the same as or different from each other, and all n groups of R⁵, R⁶, R⁷, and R⁸ may be the same as or different from each other.

In Formulae (XXV) to (XXVIII), the alkyl or aryl group having 1 to 12 carbon atoms that may be substituted represented by R¹ to R⁸ is not particularly limited, and examples thereof include alkyl groups such as methyl, ethyl, propyl, isopropyl, butyl, isobutyl, sec-butyl, and tert-butyl; aryl groups such as phenyl, 1-naphthyl, and 2-naphthyl; alkyl group-substituted aryl groups such as o-tolyl, m-tolyl, p-tolyl, 2,3-xylyl, 2,4-xylyl, o-cumenyl, m-cumenyl, p-cumenyl, and mesityl; aryl group-substituted alkyl groups such as benzyl and phenethyl; and the like, and examples of the substituent groups to the groups above include alkyl groups, alkoxyl groups, aryl groups, a hydroxyl group, an amino group, an epoxy group, a vinyl group, hydroxyalkyl groups, alkylamino groups and the like.

Among them, aryl groups are preferable, and a phenyl or hydroxyphenyl group is more preferable, from the viewpoints of the heat resistance and moisture resistance of the epoxy resin molding material.

The alkylene or arylene group having 1 to 4 carbon atoms represented by A is not particularly limited, and example thereof include methylene, ethylene, propylene, isopropylene, butylene, isobutylene, phenylene, tolylene, xylylene, naphthylene and biphenylen groups, and the like; arylene groups are preferable, and among them, a phenylene group is more preferable from the viewpoints of the heat resistance and moisture resistance of the epoxy resin molding material.

The cyclic phosphazene compound may be a polymer of one of the units represented by Formulae (XXV) to (XXVIII), a copolymer of the units represented by Formulae (XXV) and (XXVI), or a copolymer of the units represented by Formulae (XXVII) and (XXVIII); and, if it is a copolymer, the copolymer may be a random, block or alternating copolymer. The copolymerization molar ratio m/n is not particularly limited, but preferably 1/0 to 1/4, more preferably 1/0 to 1/1.5, for improvement in the heat resistance and strength of the hardened epoxy-resin product. The polymerization degree m+n is 1 to 20, preferably 2 to 8, and more preferably 3 to 6.

Favorable examples of the cyclic phosphazene compounds include the polymers represented by the following Formula (XXIX), the copolymers represented by the following Formula (XXX), and the like:

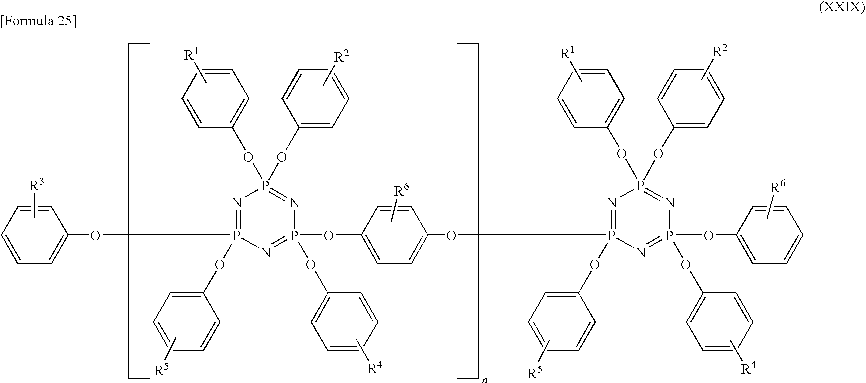

(in Formula (XXIX), m is an integer of 0 to 9; and R¹ to R⁶ each independently represent a hydrogen atom or a hydroxyl group), and

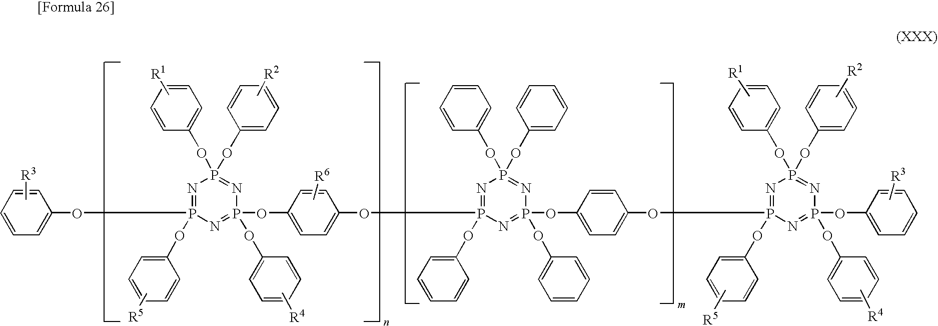

In Formula (XXX), each of m and n is an integer of 0 to 9; R¹ to R⁶ each independently represent a hydrogen atom or a hydroxyl group. Alternatively, the cyclic phosphazene compound represented by Formula (XXX) above may be a copolymer containing n recurring units (a) and m recurring units (b) shown below alternately, blockwise, or random, but preferably a random copolymer. In recurring unit (a), R¹ to R⁵ each independently represent a hydrogen atom or a hydroxyl group:

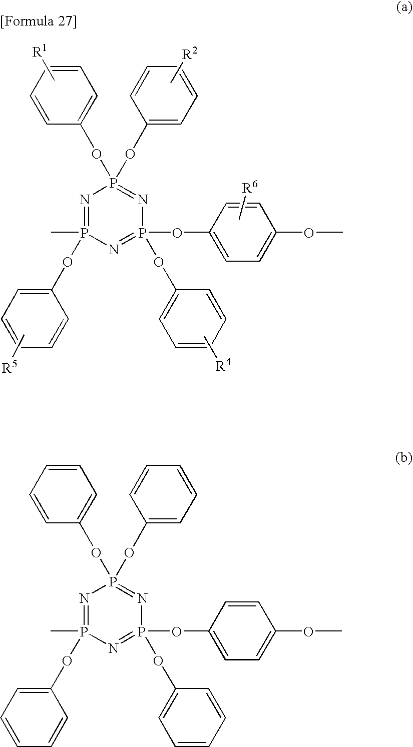

Among them, the cyclic phosphazene compound is preferably a compound containing a polymer in which m in Formula (XXIX) is 3 to 6 as the principal component, or that containing a copolymer, in which all of R¹ to R⁶ in Formula (XXX) are hydrogen atoms or only one of then is a hydroxyl group, m/n is 1/2 to 1/3, and m+n is 3 to 6, as the principal component. Commercially available phosphazene compounds include SPE-100 (trade name, manufactured by Otsuka Chemical Co., Ltd.) and others.

The blending rate of the phosphorus atom-containing compound (G) is not particularly limited, and preferably 0.01 to 50 mass %, more preferably 0.1 to 10 mass %, and still more preferably 0.5 to 3 mass %, as phosphorus atom with respect to all other components excluding the inorganic filler (J). A blending rate of less than 0.01 mass % leads to insufficient flame resistance, while a blending rate of more than 50 mass % to deterioration in moldability and moisture resistance.

In the invention, a straight-chain oxidized polyethylene having a weight-average molecular weight of 4,000 or more (H) and an ester compound (I) of a copolymer of an α-olefin having 5 to 30 carbon atoms and maleic anhydride with a monovalent alcohol having 5 to 25 carbon atoms may also be contained, from the viewpoint of release efficiency in the invention. The straight-chain oxidized polyethylene having a weight-average molecular weight of 4,000 or more (H) functions as a releasing agent. The straight-chain polyethylene is a polyethylene having the number of carbons of the side chain alkyl chain approximately 10% or less of the number of carbons in the main chain alkyl chain, and generally classified as an polyethylene having a penetration of 2 or less.

The oxidized polyethylene is also a polyethylene having a certain acid value. The weight-average molecular weight of the component (H) is preferably 4,000 or more from the viewpoint of release efficiency, and preferably 30,000 or less, more preferably 5,000 to 20,000, and still more preferably 7,000 to 15,000, from the viewpoints of adhesiveness and staining of mold and package. The weight-average molecular weight is a value determined by using a high-temperature GPC (gel-permeation chromatography). The method of determining the high temperature GPC in the present invention is as follows:

Analytical instrument: high temperature GPC manufactured by Waters

(Solvent: dichlorobenzene

Temperature: 140° C.,

Standard substance: polystyrene)

Column: trade name: PL gel MIXED-B, manufactured by Polymer Laboratories

10 μm (7.5 mm×300 mm)×2 columns

Flow rate: 1.0 ml/minute (sample concentration: 0.3 wt/vol %)

(injection: 100 μl)

The acid value of the component (H) is not particularly limited, but preferably 2 to 50 mg/KOH, more preferably 10 to 35 mg/KOH, from the viewpoint of release efficiency.

The blending rate of the component (H) is not particularly limited, but preferably 0.5 to 10 mass %, more preferably 1 to 5 mass %, with respect to the epoxy resin (A). A blending rate of less than 0.5 mass % leads to deterioration in release efficiency, while a blending rate of more than 10 mass % to insufficient improvement in adhesiveness and resistance to mold and package staining.

The ester compound (I) of a copolymer of an α-olefin having 5 to 30 carbon atoms and maleic anhydride with a monovalent alcohol having 5 to 25 carbon atoms (I) for use in the present invention also functions as a releasing agent, and is highly compatible both with the component (H) straight-chain oxidized polyethylene and the component epoxy resin (A) and effective in preventing deterioration in adhesiveness and mold/package staining.

The α-olefin having 5 to 30 carbon atoms used as the component (I) is not particularly limited, and examples thereof include straight-chain α-olefins such as 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 1-dococene, 1-tricocene, 1-tetracocene, 1-pentacocene, 1-hexacocene, and 1-heptacocene; branched α-olefins such as 3-methyl-1-butene, 3,4-dimethyl-pentene, 3-methyl-1-nonene, 3,4-dimethyl-octene, 3-ethyl-1-dodecene, 4-methyl-5-ethyl-1-octadecene, and 3,4,5-triethyl-1-1-eicosene; and the like, and these olefins may be used alone or in combination of two or more. Among them, straight-chain α-olefin having 10 to 25 carbon atoms are preferable; and straight-chain α-olefins having 15 to 25 carbon atoms such as 1-eicosene, 1-dococene, and 1-tricocene are more preferable.

The monovalent alcohol having 5 to 25 carbon atoms for use in the component (I) is not particularly limited, and examples thereof include straight-chain or branched aliphatic saturated alcohols such as amyl alcohol, isoamyl alcohol, hexyl alcohol, heptyl alcohol, octyl alcohol, capryl alcohol, nonyl alcohol, decyl alcohol, undecyl alcohol, lauryl alcohol, tridecyl alcohol, myristyl alcohol, pentadecyl alcohol, cetyl alcohol, heptadecyl alcohol, stearyl alcohol, nonadecyl alcohol, and eicosyl alcohol; straight-chain or branched aliphatic unsaturated alcohols such as hexenol, 2-hexen-1-ol, 1-hexen-3-ol, pentenol, and 2-methyl-1-pentenol; alicyclic alcohols such as cyclopentanol and cyclohexanol; aromatic alcohols such as benzyl alcohol and cinnamyl alcohol; heterocyclic alcohols such as furfuryl alcohol; and the like, and these solvents may be used alone or in combination of two or more. Among them, straight-chain alcohols having 10 to 20 carbon atoms are preferable, and straight-chain aliphatic saturated alcohols having 15 to 20 carbon atoms are more preferable.

The copolymer of an α-olefin having 5 to 30 carbon atoms and maleic anhydride in the component (I) according to the present invention is not particularly limited, and examples thereof include the compounds represented by the following General Formula (XXXI), the compounds represented by the following General Formula (XXXII), and the like; and commercial products thereof include Nissan Electol-WPB-1 prepared from 1-eicosene, 1-dococene and 1-tetracene (trade name, manufactured by NOF Corporation Co., Ltd.) and others:

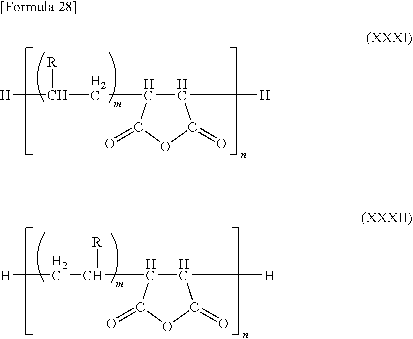

(in General Formulae (XXXI) and (XXXII), R is a group selected from monovalent aliphatic hydrocarbon groups having 3 to 28 carbon atoms; n is an integer of 1 or more; and m is a positive number).

In General Formulae (XXXI) and (XXXII), m representing an amount (mole) of the α-olefin copolymerized with respect to 1 mole of maleic anhydride is not particularly limited, but preferably 0.5 to 10, more preferably 0.9 to 1.1.

The method of preparing the component (I) is not particularly limited, and any one of common copolymerization methods may be used. An organic solvent dissolving the α-olefin and maleic anhydride may be used in the reaction. The organic solvent is not particularly limited; toluene is preferable; and an alcohol, ether, amine, or other solvent may also be used. The reaction temperature may vary according to the organic solvent used, but is preferably 50 to 200° C., more preferably 80 to 120° C., from the viewpoints of reactivity and productivity. The reaction period is not particularly limited if the copolymer can be prepared, but preferably 1 to 30 hours, more preferably 2 to 15 hours, and still more preferably 4 to 10 hours, from the viewpoint of productivity. After reaction, unreacted raw materials and solvent may be removed as needed, for example, by heating under reduced pressure. The temperature is preferably 100 to 220° C., more preferably 120 to 180° C.; the pressure is preferably 13.3×10³ Pa or less, more preferably 8×10³ Pa or less; and the period is preferably 0.5 to 10 hours. A reaction catalyst such as amine and acid may also be used as needed in the reaction. The pH of the reaction system is preferably, approximately 1 to 10.

The method of esterifying the copolymer in component (I) with a monovalent alcohol having 5 to 25 carbon atoms is not particularly limited, and any one of common methods, for example addition reaction of the monovalent alcohol and the copolymer, may be used. The reaction ratio of the copolymer to the monovalent alcohol in reaction is not particularly limited and arbitrary, but preferably adjusted properly according to the desirable encapsulated epoxy-resin molding composition, because the hydrophilicity thereof is controlled by the reaction molar ratio. For example, an organic solvent dissolving the copolymer may be used in the reaction. The organic solvent is not particularly limited; toluene is preferable; and an alcohol, ether, amine, or other solvent may be used. The reaction temperature may vary according to the kind of the organic solvent used, but is preferably 50 to 200° C., more preferably 80 to 120° C., from the viewpoints of reactivity and productivity. The reaction period is not particularly limited, but preferably 1 to 30 hours, more preferably 2 to 15 hours, and still more preferably 4 to 10 hours, from the viewpoint of productivity. After reaction, unreacted raw materials and solvent may be removed as needed, for example, by heating under reduced pressure. As for the condition, the temperature is preferably 100 to 220° C., more preferably 120 to 180° C.; the pressure is preferably 13.3×10³ Pa or less, more preferably 8×10³ Pa or less; and the period is preferably 0.5 to 10 hours. A reaction catalyst such as amine and acid may also be used as needed in the reaction. The pH of the reaction system is preferably, approximately 1 to 10.

Examples of the compounds obtained by esterifying the component (I) copolymer of an α-olefin and maleic anhydride with a monovalent alcohol include the diesters represented by the following Formulae (a) and (b), compounds having one or more monoesters selected from those represented by Formulae (c) to (f) as the recurring units in the structure, and the like. Alternatively, a nonester represented by Formula (g) or (h), or a structure containing two —COOH groups due to ring opening of maleic anhydride may be contained. Examples thereof include:

(1) compounds having any one of the structures represented by Formulae (a) to (f) as the main chain skeleton;

(2) compounds having any two or more structures represented by Formulae (a) to (f) randomly, orderly, or blockwise in the main chain skeleton; and

(3) compounds containing any one or more structures represented by Formulae (a) to (f) and at least one of the structures represented by Formulae (g) and (h) randomly, orderly, or blockwise in the main chain skeleton, and these compounds may be used alone or in combination of two or more.

In addition, one or both of a compound containing the structures represented by Formulae (g) and (h) randomly, orderly, or blockwise in the main chain skeleton (4), and a compound containing the structure represented by Formula (g) or (h) in the main chain skeleton (5) may be contained.

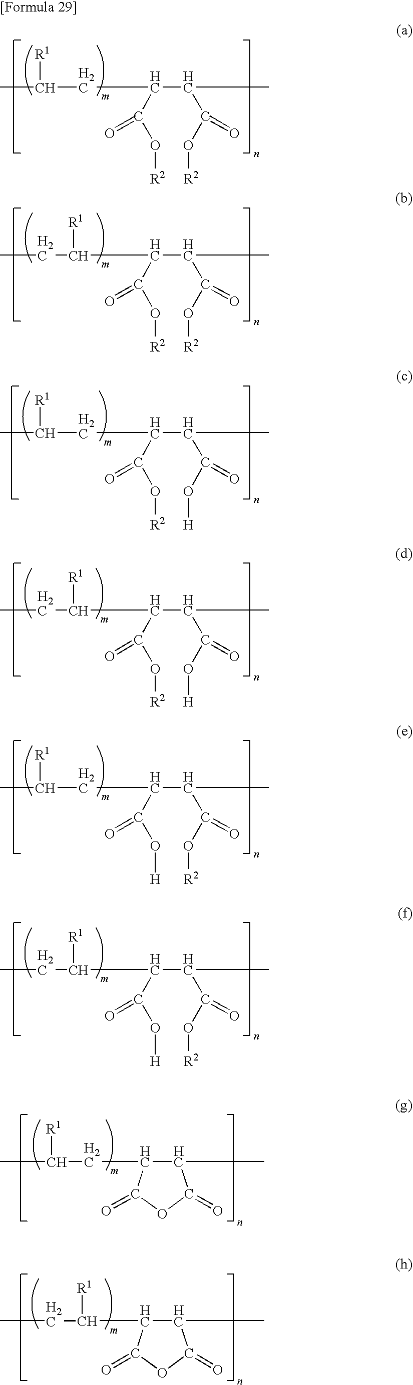

(in Formulae (a) to (h), R¹ is a group selected from monovalent aliphatic hydrocarbon groups having 3 to 28 carbon atoms; R² is a group selected from monovalent hydrocarbon groups having 5 to 25 carbon atoms; and m is a positive number).

In Formulae (a) to (h) above, m representing an amount (mole) of the α-olefin copolymerized with respect to 1 mole of maleic anhydride is not particularly limited, but preferably 0.5 to 10, more preferably 0.9 to 1.1.

The monoesterification rate of the component (I) is selected freely according to the combination with the component (H), but preferably 20% or more from the viewpoint of release efficiency, and the component (I) is preferably a compound containing one or more monomers represented by any one of Formulae (c) to (f) in a total amount of preferably 20 mol % or more, more preferably 30 mol % or more.

The weight-average molecular weight of the component (I) is preferably 5,000 to 100,000, more preferably 10,000 to 70,000, and still more preferably 15,000 to 50,000, from the viewpoints of mold/package staining and moldability. A weight-average molecular weight of less than 5,000 leads to deterioration in the resistance to mold/package staining, while a molecular weight of more than 100,000 to increase in the softening point of the compound and deterioration in blending efficiency and others. The weight-average molecular weight is a value obtained by using a normal-temperature GPC. The method of determining the weight-average molecular weight by normal-temperature GPC in the present invention is as follows:

Analytical instrument: LC-6C, manufactured by Shimadzu Corporation

Column: Shodex KF-802.5+KF-804+KF-806

Solvent: THF (tetrahydrofuran)

Temperature: room temperature (25° C.)

Standard substance: polystyrene

Flow rate: 1.0 ml/minute (sample concentration: approximately 0.2 wt/vol %)

Injection: 200 μl

The blending rate of the component (I) is not particularly limited, but preferably 0.5 to 10 mass %, more preferably 1 to 5 mass %, with respect to the epoxy resin (A). A blending rate of less than 0.5 mass % leads to deterioration in release efficiency, while a blending rate of more than 10 mass % to deterioration in reflow resistance.

At least one of the releasing agents according to the invention, i.e., component (H) or (I), is preferably mixed with part or all of the component epoxy resin (A) previously in preparation of the epoxy resin molding material according to the present invention, from the viewpoints of reflow resistance and preventing staining of mold and package. Preliminary mixing of part or all of the components (H) and (I) with the component (A) is effective in increasing dispersion of the releasing agent in the base resin and preventing deterioration in reflow resistance and staining of mold and package.

The preliminary mixing method is not particularly limited, and may be any method, if part or all of the components (H) and (I) can be dispersed in the component epoxy resin (A) well, and, for example, the mixture of the components (H) and (I) and the component (A) are agitated at a temperature of room temperature to 220° C. for 0.5 to 20 hours. From the viewpoints of filling ability and productivity, the temperature is preferably 100 to 200° C., more preferably 150 to 170° C., and the agitation period is preferably 1 to 10 hours, more preferably 3 to 6 hours.

At least one of the components (H) and (I) for preliminary mixing may be previously mixed with the total amount of the component (A), and preliminary mixing with part of the component (A) is also effective in giving favorable effect. In such a case, the amount of the component (A) used in preliminary mixing is preferably 10 to 50 mass % with respect to the total amount of the component (A).

Although preliminary mixing of component (H) or (I) with component (A) is effective in improving filling ability, preliminary mixing of both components (H) and (I) with component (A) is more effective and thus preferable. The order of adding the three components during preliminary mixing is not particularly limited, and all components may be added simultaneously or a component (H) or (I) may be first added with component (A) and the other component added and mixed later.

A known non-halogen, non-antimony flame retardant may be blended as needed in the encapsulated epoxy-resin molding composition according to the present invention for further improvement in flame resistance. Examples thereof include nitrogen-containing compounds such as melamine, melamine derivatives, melamine-modified phenol resins, triazine ring-containing compounds, cyanuric acid derivatives, and isocyanuric acid derivatives; metal element-containing compounds such as aluminum hydroxide, zinc stannate, zinc borate, zinc molybdate, and dicyclopentadienyl iron; and the like, and these compounds may be used alone or in combination of two or more.

An anion exchanger may also be added to the encapsulated epoxy-resin molding composition according to the present invention, for improvement in moisture resistance and high-temperature storage stability of semiconductor elements such as IC. The anion exchanger is not particularly limited, and any one of known exchangers may be used, and examples thereof include hydrotalcites, and hydroxides of an element selected from magnesium, aluminum, titanium, zirconium, bismuth, and the like, and these compounds may be used alone or in combination of two or more. Among them, the hydrotalcites represented by the following Compositional Formula (XXXIII) are preferable. The compound represented by (XXXIII) is commercially available as DHT-4A, trade name, from Kyowa Chemical Industry Co., Ltd.

(Formula 30)

Mg₁₋ₓAlₓ(OH)₂(CO₃)_{x/2}−mH₂O (XXXIII)

(in Formula (XXXIII), 0<x≦0.5, and m is a positive number).

In addition, other additives, including a releasing agent such as higher fatty acid, higher fatty acid metal salt, ester-based wax, polyolefin wax, polyethylene, or oxidated polyethylene; a colorant such as carbon black; and a stress-relaxing agent such as silicone oil or silicone rubber powder, may be added as needed to the encapsulated epoxy-resin molding composition according to the present invention.

The encapsulated epoxy-resin molding composition according to the present invention may be prepared by any method, if various raw materials are dispersed and mixed uniformly thereby. In a general method, raw materials in particular blending amounts are mixed sufficiently, for example in a mixer, mixed or melt-blended, for example in a mixing roll, extruder, mortar and pestle machine, or planetary mixer, cooled, and degasses and pulverized as needed. The raw materials may be tabletized previously into the size and weight suitable for the molding condition as needed.

A low-pressure transfer molding method is most commonly used as the method of producing electronic component devices such as semiconductor device by using the encapsulated epoxy-resin molding composition according to the present invention as a sealer, but other method such as injection molding or compression molding may be used instead. Yet another method such as discharging, molding, or printing may be used.

The electronic component devices according to the present invention having an element sealed with the encapsulated epoxy-resin composition according to the present invention include electronic component devices having an element, for example as an active element such as semiconductor chip, transistor, diode, or thyristor or a passive element such as capacitor, resistor or coil, formed on a supporting material or mounting substrate such as lead frame, wired tape support, wiring board, glass, or silicon wafer, of which desirable regions are sealed with the encapsulated epoxy-resin molding composition according to the present invention, and the like.

The substrate for mounting is not particularly limited, and examples thereof include organic substrates, organic films, ceramic substrates, interposer substrates such as of glass plate, glass plates for liquid crystal, MCM (Multi Chip Module) substrates, hybrid IC substrates, and the like.

Examples of the electronic component devices include semiconductor devices, and specific examples thereof include resin-sealed IC's prepared by mounting an element such as semiconductor chip on a lead frame (die pad), connecting the terminal and lead areas of the element such as bonding pad by wire bonding or bumping, and then, sealing the element with the encapsulated epoxy resin-molding composition according to the present invention for example by transfer molding, such as DIP (Dual Inline Package), PLCC (Plastic Leaded Chip Carrier), QFP (Quad Flat Package), SOP (Small Outline Package), SOJ (Small Outline J-lead Package), TSOP (Thin Small Outline Package), and TQFP (Thin Quad Flat Package); TCP's (Tape Carrier Packages) prepared by sealing a semiconductor chip lead-bonded to a tape support with the encapsulated epoxy-resin molding composition according to the present invention; semiconductor devices mounted on bare chip, such as COB's (Chip On Board) and COG (Chip On Glass), prepared by sealing a semiconductor chip connected to a wiring formed on a wiring board or glass plate with the encapsulated epoxy-resin molding composition according to the present invention, for example by wire bonding, flip-chip bonding, or soldering; hybrid IC's prepared by sealing an active element such as semiconductor chip, transistor, diode, or thyristor and/or a passive element such as capacitor, resistor, or coil connected to a wiring formed on a wiring board or glass with the encapsulated epoxy-resin molding composition according to the present invention, for example by wire bonding, flip chip bonding, or solder; BGA's (Ball Grid Arrays), CSP's (Chip Size Packages), and MCP's (Multi Chip Packages) prepared by mounting a semiconductor chip on an interposer substrate having a terminal for connection to a MCM (Multi Chip Module) mother board, connecting the semiconductor chip to a wiring formed on the interposer substrate by bumping or wire bonding, and then, sealing the semiconductor chip-sided surface of the substrate with the encapsulated epoxy-resin molding composition according to the present invention; and the like. The semiconductor device may be a stacked package in which two or more elements are mounted as stacked (laminated) on a mounting substrate, or a simultaneously sealed package in which two or more elements are sealed simultaneously with an encapsulated epoxy-resin molding composition.

### EXAMPLES

Hereinafter, the present invention will be described with reference to Examples, but it should be understood that the scope of the present invention is not limited to these Examples. Hereinafter, magnesium hydroxide particle will be referred to as magnesium hydroxide particle or magnesium hydroxide.

(Preparative Examples of Magnesium Hydroxide)

(1) Magnesium Hydroxide 1

Electrolytic MgO having a crystallite diameter of 58.3×10⁻⁹ m (manufactured by Tateho Chemical Industries Co., Ltd.) was pulverized in a ball mill and sieved through a 200-mesh sieve by a wet method. The sieved particles were added as seed crystals to a container having a capacity of 20 L and containing 10 L of acetic acid at a concentration of 0.02 mol/L, to an oxide (Mgo) concentration of 100 g/L. The MgO-containing mixture solution was subjected to hydration reaction, while kept at 90° C. and agitated with a high speed stirrer (trade name: Homomixer, manufactured by Tokushu Kika Kogyo) at a turbine-blade peripheral speed of 10 m/s for 4 hours. The reaction product obtained was screened through a 500-mesh sieve, and the sieved microparticles were filtered, washed with water, and dried, to give magnesium hydroxide particles. The particle shape, the length in the c-axis direction (Lc) and the volume (V) of the magnesium hydroxide particles obtained were summarized in Table 1.

(2) Magnesium Hydroxide 2

Magnesium hydroxide 2 grown more than the magnesium hydroxide particles 1 obtained was prepared similarly, except that 30 g of the magnesium hydroxide particles 1 obtained above were suspended as seed crystals in 10 L of 0.02 mol/L acetic acid. The values indicating the particle shape of the magnesium hydroxide particles are summarized in Table 1.

(3) Magnesium Hydroxide 3

500 g of the magnesium hydroxide particles 1 obtained above and 500 g of the magnesium hydroxide particles 2 were placed in a V-shaped mixer and mixed therein for 20 minutes, to give magnesium hydroxide 3. The values indicating the particle shape of the magnesium hydroxide particles are summarized in Table 1.

(4) Magnesium Hydroxide 4

ECOMAG Z-10 (trade name) manufactured by Tateho Chemical Industries Co., Ltd. was used as it was as the magnesium hydroxide. The values indicating the particle shape of the magnesium hydroxide particles are summarized in Table 1.

(5) Magnesium Hydroxide 5

Finemag MO (trade name) manufactured by TMG Corporation was used as it was as the magnesium hydroxide. The values indicating the particle shape of the magnesium hydroxide particles are summarized in Table 1.

[Table 1]

TABLE 1
Various magnesium hydroxides

| | Magnesium hydroxide for Example | | | | |
|---|---|---|---|---|---|
| Item | 1 | 2 | 3 | 4 | 5 |
| Starting | Electrolytic | Electrolytic | Electrolytic | — | — |
| material | MgO | MgO | MgO | | |
| Particle | Hexagonal- | Hexagonal- | Hexagonal- | Octahedron | Hexagonal- |
| shape | column | column | column | shape | plate |
| | shape | shape | shape | | shape |
| Production | Hydrated | Hydrated | Hydrated | Hydrated | Hydro- |
| process | once | once | once | twice | thermal |
| | | | | | synthesis |
| Lc (×10⁻⁶ m) | 0.67 | 1.67 | 1.67 | 0.58 | 0.30 |
| V (×10⁻⁶ m³) | 0.59 | 9.76 | 10.83 | 1.04 | 0.58 |

(Preparative Example of Releasing Agent)

A copolymer of a mixture of 1-eicosene, 1-dococene and 1-tetracocene with maleic anhydride (trade name: Nissan Electol WPB-1, manufactured by NOF Corporation Co., Ltd.) was used as the copolymer at α-olefin and maleic anhydride, and stearyl alcohol as monovalent alcohol; these components were dissolved in toluene and allowed to react at 100° C. for 8 hours; the mixture was heated stepwise to 160° C. while toluene was removed and then, allowed to react additionally under reduced pressure at 160° C. for 6 hours, while the unreacted raw materials were removed, to give an esterification compound having a weight-average molecular weight 34,000 and a monoesterification rate of 70 mol W (component (I): releasing agent 3). The weight-average molecular weight is a value determined by GPC, by using THF (tetrahydrofuran) as the solvent.

### Examples 1 to 17 and Comparative Examples 1 to 8

As the epoxy resin (A), used was a biphenyl-based epoxy resin having an epoxy equivalence of 196 and a melting point of 106° C. (trade name: EPIKOTE YX-4000H, manufactured by Japan Epoxy Resin Co., Ltd.) (epoxy resin 1),

a sulfur atom-containing epoxy resin having an epoxy equivalence of 245 and a melting point of 110° C. (trade name: YSLV-120TE, manufactured by Tohto Kasei Co., Ltd.) (epoxy resin 2),

aβ-naphthol-aralkyl-based epoxy resin having an epoxy equivalence of 266 and a softening point of 67° C. (trade name: ESN-175, manufactured by Tohto Kasei Co., Ltd.) (epoxy resin 3), or

an o-cresol novolak-based epoxy resin having an epoxy equivalence of 195 and a softening point 65° C. (trade name: ESCN-190, manufactured by Sumitomo Chemical Co., Ltd.) (epoxy resin 4).

As the hardening agent (B), used was a phenol-aralkyl resin having a softening point of 70° C. and a hydroxyl equivalence of 175 (trade name: Milex XLC-3L, manufactured by Mitsui Chemicals, Inc.) (hardening agent 1),

a biphenyl-base phenol resin having a softening point of 80° C. and a hydroxyl equivalence of 199 (trade name: MEH-7851, manufactured by Meiwa Plastic Industries, Ltd.) (hardening agent 2), or

a phenolic novolak resin having a softening point 80° C. and a hydroxyl equivalence of 106 (trade name: H-1, manufactured by Meiwa Plastic Industries, Ltd.) (hardening agent 3).

As the accelerator (E), used was triphenylphosphine (accelerator 1), a triphenylphosphine 1,4-benzoquinone adduct (accelerator 2), or a tributylphosphine 1,4-benzoquinone adduct (accelerator 3).

As the silane-coupling agent (F), used was γ-glycidoxypropyltrimethoxysilane (epoxysilane), or γ-anilino propyltrimethoxysilane (anilinosilane) as a secondary amino group-containing silane-coupling agent.

As the flame retardant, used was the various magnesium hydroxide (C) shown in Table 1 (magnesium hydroxide 1 to 8), zinc oxide, an aromatic condensed phosphoric ester (tradename: PX-200, manufactured by Daihachi Chemical Industry Co., Ltd.), triphenylphosphine oxide, antimony trioxide, or a brominated bisphenol-A epoxy resin having an epoxy equivalence of 397, a softening point of 69° C., and a bromine content of 49 mass % (trade name: YDB-400, manufactured by Tohto Kasei Co., Ltd.).

As the inorganic filler (J), used was spherical fused silica having an average diameter of 14.5 μm and a specific surface area 2.8 m²/g; and as other additive, used was carnauba wax (releasing agent 1). As the component (H), used was a straight-chain oxidized polyethylene having a weight-average molecular weight of 8,800, a penetration of 1, and an acid value of 30 mg/KOH, trade name: PED153, manufactured by Clariant) (releasing agent 2), the component (I) prepared above (releasing agent 3), or carbon black (trade name: MA-100, manufactured by Mitsubishi Chemical Corp.).

Respective components were mixed at the ratio shown in Tables 2 to 4, and the mixture was roll-kneaded under the condition of a kneading temperature of 80° C. and a kneading period of 10 minutes, to give respectively the compositions shown in Examples 1 to 17 and Comparative Examples 1 to 8.

[Table 2]

TABLE 2
Blending composition 1

| | Example | | | | | | | |
|---|---|---|---|---|---|---|---|---|
| Blending components | 1 | 2 | 3 | 4 | 5 | 6 | 7 | 8 |
| Epoxy resin 1 | 100 | 100 | 100 | 100 | 100 | 100 | 100 | 100 |
| Epoxy resin 2 | | | | | | | | |
| Epoxy resin 3 | | | | | | | | |
| Epoxy resin 4 | | | | | | | | |
| Brominated | | | | | | | | |
| epoxy resin | | | | | | | | |
| Hardening agent1 | 89 | 89 | 89 | 89 | 89 | 89 | 89 | 89 |
| Hardening agent2 | | | | | | | | |
| Hardening agent3 | | | | | | | | |
| Hardening | | | | | | | | |
| accelerator 1 | | | | | | | | |
| Hardening | 2.0 | 2.0 | 2.0 | 2.0 | 2.0 | 2.0 | 2.0 | 2.0 |
| accelerator 2 | | | | | | | | |
| Hardening | | | | | | | | |
| accelerator 3 | | | | | | | | |
| Magnesium | | | | | | | | |
| hydroxide 1 | | | | | | | | |
| Magnesium | 10 | 50 | 100 | 200 | 100 | 100 | 100 | 100 |
| hydroxide 2 | | | | | | | | |
| Magnesium | | | | | | | | |
| hydroxide 3 | | | | | | | | |
| Magnesium | | | | | | | | |
| hydroxide 4 | | | | | | | | |
| Magnesium | | | | | | | | |
| hydroxide 5 | | | | | | | | |
| Zinc oxide | | | | | | 5.0 | | |
| Phosphate ester | | | | | | | 10.0 | |
| Triphenyl | | | | | | | | 10.0 |
| phosphine oxide | | | | | | | | |
| Antimony trioxide | | | | | | | | |
| Epoxy silane | 1.0 | 1.0 | 1.0 | 1.0 | | 1.0 | 1.0 | 1.0 |
| Anilinosilane | | | | | 1.0 | | | |
| Releasing agent 1 | 2.0 | 2.0 | 2.0 | 2.0 | 2.0 | 2.0 | 2.0 | 2.0 |
| Releasing agent 2 | | | | | | | | |
| Releasing agent 3 | | | | | | | | |
| Carbon black | 2.5 | 2.5 | 2.5 | 2.5 | 2.5 | 2.5 | 2.5 | 2.5 |
| Fused silica | 471 | 686 | 953 | 1488 | 953 | 980 | 975 | 1007 |
| Filler amount (wt %) | 84 | 84 | 84 | 84 | 84 | 84 | 84 | 84 |

[Table 3]

TABLE 3
Blending composition 2

| Blending | Example | | | | | | | | |
|---|---|---|---|---|---|---|---|---|---|
| components | 9 | 10 | 11 | 12 | 13 | 14 | 15 | 16 | 17 |
| Epoxy resin 1 | 100 | 100 | | | | 100 | | 100 | 100 |
| Epoxy resin 2 | | | 100 | | | | | | |
| Epoxy resin 3 | | | | 100 | | | | | |
| Epoxy resin 4 | | | | | 100 | | 100 | | |
| Brominated | | | | | | | | | |
| epoxy resin | | | | | | | | | |
| Hardening agent1 | 89 | 89 | 71 | 66 | 90 | | | 89 | 89 |
| Hardening agent2 | | | | | | 102 | | | |
| Hardening agent3 | | | | | | | 54 | | |
| Hardening | | 2.0 | | | | | | | |
| accelerator 1 | | | | | | | | | |
| Hardening | | | 2.0 | 2.0 | 2.0 | 2.0 | 2.0 | 2.0 | 2.0 |
| accelerator 2 | | | | | | | | | |
| Hardening | 2.0 | | | | | | | | |
| accelerator 3 | | | | | | | | | |
| Magnesium | | | | | | | | | |
| hydroxide 1 | | | | | | | | | |
| Magnesium | 100 | 100 | 100 | 100 | 100 | 100 | 150 | 100 | |
| hydroxide 2 | | | | | | | | | |
| Magnesium | | | | | | | | | 100 |
| hydroxide 3 | | | | | | | | | |
| Magnesium | | | | | | | | | |
| hydroxide 4 | | | | | | | | | |
| Magnesium | | | | | | | | | |
| hydroxide 5 | | | | | | | | | |
| Zinc oxide | | | | | | | | | |
| Phosphate ester | | | | | | | | | |
| Triphenyl | | | | | | | | | |
| phosphine oxide | | | | | | | | | |
| Antimony | | | | | | | | | |
| trioxide | | | | | | | | | |
| Epoxy silane | 1.0 | 1.0 | 1.0 | 1.0 | 1.0 | 1.0 | 1.0 | 1.0 | 1.0 |
| Anilinosilane | | | | | | | | | |
| Releasing | 2.0 | 2.0 | 2.0 | 2.0 | 2.0 | 2.0 | 2.0 | | 2.0 |
| agent 1 | | | | | | | | | |
| Releasing | | | | | | | | 2.0 | |
| agent 2 | | | | | | | | | |
| Releasing | | | | | | | | 2.0 | |
| agent 3 | | | | | | | | | |
| Carbon black | 2.5 | 2.5 | 2.5 | 2.5 | 2.5 | 2.5 | 2.5 | 2.5 | 2.5 |
| Fused silica | 953 | 953 | 858 | 827 | 956 | 1019 | 1034 | 646 | 953 |
| Filler amount | 84 | 84 | 84 | 84 | 84 | 84 | 84 | 84 | 84 |
| (wt %) | | | | | | | | | |

[Table 4]

TABLE 4
Blending composition 3

| | Comparative Example | | | | | | | |
|---|---|---|---|---|---|---|---|---|
| Blending components | 1 | 2 | 3 | 4 | 5 | 6 | 7 | 8 |
| Epoxy resin 1 | 100 | 100 | 100 | 100 | 100 | 100 | 100 | 85 |
| Epoxy resin 2 | | | | | | | | |
| Epoxy resin 3 | | | | | | | | |
| Epoxy resin 4 | | | | | | | | |
| Brominated | | | | | | | | 15 |
| epoxy resin | | | | | | | | |
| Hardening agent1 | 89 | 89 | 89 | 89 | 89 | 89 | 89 | 83 |
| Hardening agent2 | | | | | | | | |
| Hardening agent3 | | | | | | | | |
| Hardening | | | | | | | | |
| accelerator 1 | | | | | | | | |
| Hardening | 2.0 | 2.0 | 2.0 | 2.0 | 2.0 | 2.0 | 2.0 | 2.0 |
| accelerator 2 | | | | | | | | |
| Hardening | | | | | | | | |
| accelerator 3 | | | | | | | | |
| Magnesium | 100 | | | | | | | |
| hydroxide 1 | | | | | | | | |
| Magnesium | | | | | | | | |
| hydroxide 2 | | | | | | | | |
| Magnesium | | | | | | | | |
| hydroxide 3 | | | | | | | | |
| Magnesium | | 100 | | | | | | |
| hydroxide 4 | | | | | | | | |
| Magnesium | | | 100 | | | | | |
| hydroxide 5 | | | | | | | | |
| Zinc oxide | | | | | 5.0 | | | |
| Phosphate ester | | | | | | 20.0 | | |
| Triphenyl | | | | | | | 20.0 | |
| phosphine oxide | | | | | | | | |
| Antimony trioxide | | | | | | | | |
| Epoxy silane | 1.0 | 1.0 | 1.0 | 1.0 | 1.0 | 1.0 | 1.0 | 1.0 |
| Anilinosilane | | | | | | | | |
| Releasing agent 1 | 2.0 | 2.0 | 2.0 | 2.0 | 2.0 | 2.0 | 2.0 | 2.0 |
| Releasing agent 2 | | | | | | | | |
| Releasing agent 3 | | | | | | | | |
| Carbon black | 2.5 | 2.5 | 2.5 | 2.5 | 2.5 | 2.5 | 2.5 | 2.5 |
| Fused silica | 953 | 953 | 953 | 1053 | 1048 | 1160 | 1160 | 1017 |
| Filler amount (wt %) | 84 | 84 | 84 | 84 | 84 | 84 | 84 | 84 |

The properties of each of the encapsulated epoxy resin compositions prepared Examples 1 to 17 and Comparative Examples 1 to 8 were determined in the following tests. Results are summarized in Tables 5 to 7.

(1) Spiral Flow

The flow distance (cm) of each encapsulated epoxy-resin molding composition was determined in a transfer-molding machine by molding it, by using a mold compatible with EMMI-1-66 for spiral flow measurement under the condition of a mold temperature of 180° C., a molding pressure of 6.9 MPa, and a hardening period of 90 seconds.

(2) Hardness when Hot

Each encapsulated epoxy-resin molding composition was molded into a circular disk having a diameter of 50 mm and a thickness of 3 mm under the molding condition of (1), and the hardness thereof was determined immediately by using a Shore D hardness meter.

(3) Flame Resistance

Each encapsulated epoxy-resin molding composition was molded under the molding condition of (1) by using a mold for a sample piece having a thickness of 1.6 mm ( 1/16 inch) and hardened at 180° C. additionally for 5 hours, and the flame resistance thereof is determined according to the test method of UL-94.

(4) Acid Resistance

A 80-pin flat package (QFP) having an external dimension of 20 mm×14 mm×2 mm carrying a silicon chip of 8 mm×10 mm×0.4 mm was molded and additionally hardened under the condition (3) above with each of the encapsulated epoxy-resin molding compositions and additionally solder-plated, and the degree of surface corrosion was observed visually, from favorable into groups ⊚, ◯, Δ, and X.

(5) Shear-Release Efficiency

Each of the encapsulated epoxy-resin molding compositions above was molded in a mold for forming a circular disk having a diameter of 20 mm that contains a chrome-plated stainless steel plate of 50 mm in length×35 mm in width×0.4 mm in thickness, and the maximum pull-out force when the stainless steel plate was pulled out immediately after molding under the condition (1) above was determined. The same test was repeated with the same stainless steel plate ten times, and the shear-release efficiency was evaluated by determining the average pull-out force in the second to tenth tests.

(6) Reflow Resistance

An 80-pin flat package (QFP) having an external dimension of 20 mm×14 mm×2 mm carrying a silicon chip of 8 mm×10 mm×0.4 mm was molded and additionally hardened under the condition of (3) with each encapsulated epoxy-resin molding composition, moistened under the condition of 85° C. and 85% RH, and subjected to reflow treatment at 240° C. for 10 second at a particular time interval, and presence of cracks was observed. The reflow resistance was evaluated by the number of cracks formed on five test packages.

(7) Moisture Resistance

An 80-pin flat package (QFP) having an external dimension of 20 mm×14 mm×2.7 mm carrying a test silicon chip of 6 mm×6 mm×0.4 mm in size with aluminum wiring having a line width 10 μm and a thickness 1 μm on an oxide layer having thickness of 5 μm was molded and additionally hardened under the condition of (3) with each encapsulated epoxy-resin molding composition and moistened after pretreatment; disconnection defects by aluminum wiring corrosion was analyzed at a particular time interval; and the moisture resistance thereof is evaluated, based on the number of defects on ten test packages.

In the pretreatment, the flat package was moistened under the condition of 85° C. and 85% RH for 72 hours and subjected to a vapor-phase reflow treatment at 215° C. for 90 seconds. Then, it is moistened under the condition of 0.2 MPa and 121° C.

(8) High-Temperature Storage Characteristics

A test silicon chip of 5 mm×9 mm×0.4 mm in size carrying aluminum wiring having a line width 10 μm and a thickness of 1 μm formed on the oxide layer having a thickness of 5 μm was mounted on a 42-alloy lead frame partially silver-plated with silver paste; a 16-bottle DIP (Dual Inline Package), in which the bonding pad and the inner lead of the chip were connected to each other with Au wire at 200° C. by using a thermosonic wire bonding machine, was prepared by molding and additional hardening under the condition of (3) with each encapsulated epoxy-resin molding composition, and stored in a tank at a high temperature of 200° C.; the DIP was withdrawn from the tank at a particular time interval and subjected to a continuity test; and the high-temperature storage stability was evaluated by the number of continuity defects on ten test packages.

[Table 5]

TABLE 5
Physical properties of sealers 1

| | Example | | | | | | | |
|---|---|---|---|---|---|---|---|---|
| Properties | 1 | 2 | 3 | 4 | 5 | 6 | 7 | 8 |
| Flame | | | | | | | | |
| resistance: | | | | | | | | |
| Total | 49 | 38 | 17 | 0 | 14 | 10 | 8 | 9 |
| afterflame | | | | | | | | |
| time (s) | | | | | | | | |
| Judgment | V-0 | V-0 | V-0 | V-0 | V-0 | V-0 | V-0 | V-0 |
| Spiral flow | 138 | 130 | 126 | 105 | 129 | 123 | 131 | 127 |
| (cm) | | | | | | | | |
| Hardness when | 80 | 77 | 75 | 71 | 79 | 73 | 70 | 73 |
| hot (Shore D) | | | | | | | | |
| Acid resistance | ◯ | ◯ | ◯ | Δ | ◯ | ◯ | ◯ | ◯ |
| Release | 3.5 | 3.8 | 4.2 | 8.6 | 3.9 | 4.2 | 5.0 | 4.8 |
| efficiency | | | | | | | | |
| Reflow | | | | | | | | |
| resistance | | | | | | | | |
| 48 h | 0/5 | 0/5 | 0/5 | 0/5 | 0/5 | 0/5 | 0/5 | 0/5 |
| 72 h | 0/5 | 0/5 | 0/5 | 0/5 | 0/5 | 0/5 | 0/5 | 0/5 |
| 96 h | 0/5 | 0/5 | 0/5 | 3/5 | 1/5 | 0/5 | 0/5 | 0/5 |
| 168 h | 2/5 | 3/5 | 5/5 | 5/5 | 5/5 | 5/5 | 1/5 | 5/5 |
| Moisture | | | | | | | | |
| resistance | | | | | | | | |
| 100 h | 0/10 | 0/10 | 0/10 | 0/10 | 0/10 | 0/10 | 0/10 | 0/10 |
| 500 h | 0/10 | 0/10 | 0/10 | 0/10 | 0/10 | 0/10 | 0/10 | 0/10 |
| 1000 h | 0/10 | 0/10 | 0/10 | 0/10 | 0/10 | 0/10 | 0/10 | 0/10 |
| 1500 h | 0/10 | 0/10 | 0/10 | 0/10 | 0/10 | 0/10 | 2/10 | 0/10 |
| High- | | | | | | | | |
| temperature | | | | | | | | |
| storage | | | | | | | | |
| characteristics | | | | | | | | |
| 500 h | 0/10 | 0/10 | 0/10 | 0/10 | 0/10 | 0/10 | 0/10 | 0/10 |
| 1000 h | 0/10 | 0/10 | 0/10 | 0/10 | 0/10 | 0/10 | 0/10 | 0/10 |
| 1500 h | 0/10 | 0/10 | 0/10 | 0/10 | 0/10 | 0/10 | 0/10 | 0/10 |
| 2000 h | 0/10 | 0/10 | 0/10 | 0/10 | 0/10 | 0/10 | 0/10 | 0/10 |

[Table 6]

TABLE 6
Physical properties of sealers 2

| | Example | | | | | | | | |
|---|---|---|---|---|---|---|---|---|---|
| Properties | 9 | 10 | 11 | 12 | 13 | 14 | 15 | 16 | 17 |
| Flame resistance: | | | | | | | | | |
| Total afterflame time (s) | 15 | 23 | 25 | 11 | 36 | 10 | 45 | 18 | 14 |
| Judgment | V-0 | V-0 | V-0 | V-0 | V-0 | V-0 | V-0 | V-0 | V-0 |
| Spiral flow (cm) | 129 | 120 | 124 | 121 | 109 | 125 | 101 | 129 | 128 |
| Hardness when hot | 80 | 70 | 73 | 77 | 83 | 71 | 83 | 74 | 75 |
| (Shore D) | | | | | | | | | |
| Acid resistance | ◯ | ◯ | ◯ | ◯ | ◯ | ◯ | ◯ | ◯ | ◯ |
| Release efficiency | 3.2 | 5.5 | 5.5 | 3.4 | 4.0 | 6.0 | 3.1 | 4.1 | 4.1 |
| Reflow resistance | | | | | | | | | |
| 48 h | 0/5 | 0/5 | 0/5 | 0/5 | 0/5 | 0/5 | 2/5 | 0/5 | 0/5 |
| 72 h | 0/5 | 0/5 | 0/5 | 0/5 | 0/5 | 0/5 | 5/5 | 0/5 | 0/5 |
| 96 h | 1/5 | 0/5 | 0/5 | 1/5 | 5/5 | 0/5 | 5/5 | 0/5 | 0/5 |
| 168 h | 5/5 | 5/5 | 0/5 | 5/5 | 5/5 | 5/5 | 5/5 | 5/5 | 5/5 |
| Moisture resistance | | | | | | | | | |
| 100 h | 0/10 | 0/10 | 0/10 | 0/10 | 0/10 | 0/10 | 0/10 | 0/10 | 0/10 |
| 500 h | 0/10 | 0/10 | 0/10 | 0/10 | 0/10 | 0/10 | 0/10 | 0/10 | 0/10 |
| 1000 h | 0/10 | 0/10 | 0/10 | 0/10 | 0/10 | 0/10 | 0/10 | 0/10 | 0/10 |
| 1500 h | 0/10 | 0/10 | 0/10 | 0/10 | 0/10 | 0/10 | 0/10 | 0/10 | 0/10 |
| High-temperature | | | | | | | | | |
| storage | | | | | | | | | |
| characteristics | | | | | | | | | |
| 500 h | 0/10 | 0/10 | 0/10 | 0/10 | 0/10 | 0/10 | 0/10 | 0/10 | 0/10 |
| 1000 h | 0/10 | 0/10 | 0/10 | 0/10 | 0/10 | 0/10 | 0/10 | 0/10 | 0/10 |
| 1500 h | 0/10 | 0/10 | 0/10 | 0/10 | 0/10 | 0/10 | 0/10 | 0/10 | 0/10 |
| 2000 h | 0/10 | 0/10 | 0/10 | 0/10 | 0/10 | 0/10 | 0/10 | 0/10 | 0/10 |

[Table 7]

TABLE 7
Physical properties of sealers 3

| | Comparative Example | | | | | | | |
|---|---|---|---|---|---|---|---|---|
| Properties | 1 | 2 | 3 | 4 | 5 | 6 | 7 | 8 |
| Flame | | | | | | | | |
| resistance: | | | | | | | | |
| Total | 21 | 19 | 39 | 136 | 90 | 15 | 20 | 5 |
| afterflame | | | | | | | | |
| time (s) | | | | | | | | |
| Judgment | V-0 | V-0 | V-0 | NG | NG | V-0 | V-0 | V-0 |
| Spiral flow | 92 | 98 | 77 | 149 | 135 | 158 | 150 | 140 |
| (cm) | | | | | | | | |
| Hardness when | 72 | 73 | 70 | 79 | 74 | 69 | 71 | 79 |
| hot (Shore D) | | | | | | | | |
| Acid resistance | X | ◯ | X | ⊚ | ⊚ | ⊚ | ⊚ | ⊚ |
| Release | 8.9 | 6.2 | 13.5 | 3.1 | 4.2 | 8.2 | 7.7 | 3.2 |
| efficiency | | | | | | | | |
| Reflow | | | | | | | | |
| resistance | | | | | | | | |
| 48 h | 0/5 | 0/5 | 0/5 | 0/5 | 0/5 | 0/5 | 0/5 | 0/5 |
| 72 h | 0/5 | 0/5 | 0/5 | 0/5 | 0/5 | 0/5 | 0/5 | 0/5 |
| 96 h | 2/5 | 1/5 | 4/5 | 0/5 | 0/5 | 0/5 | 0/2 | 0/5 |
| 168 h | 5/5 | 5/5 | 5/5 | 2/5 | 5/5 | 3/5 | 5/5 | 1/5 |
| Moisture | | | | | | | | |
| resistance | | | | | | | | |
| 100 h | 0/10 | 0/10 | 0/10 | 0/10 | 0/10 | 0/10 | 0/10 | 0/10 |
| 500 h | 0/10 | 0/10 | 0/10 | 0/10 | 0/10 | 0/10 | 0/10 | 0/10 |
| 1000 h | 0/10 | 0/10 | 0/10 | 0/10 | 0/10 | 4/10 | 1/10 | 0/10 |
| 1500 h | 0/10 | 0/10 | 0/10 | 0/10 | 0/10 | 8/10 | 3/10 | 0/10 |
| High- | | | | | | | | |
| temperature | | | | | | | | |
| storage | | | | | | | | |
| characteristics | | | | | | | | |
| 500 h | 0/10 | 0/10 | 0/10 | 0/10 | 0/10 | 0/10 | 0/10 | 8/10 |
| 1000 h | 0/10 | 0/10 | 0/10 | 0/10 | 0/10 | 0/10 | 0/10 | 10/10 |
| 1500 h | 0/10 | 0/10 | 0/10 | 0/10 | 0/10 | 0/10 | 0/10 | 10/10 |
| 2000 h | 0/10 | 0/10 | 0/10 | 0/10 | 0/10 | 0/10 | 0/10 | 10/10 |

As for Comparative Examples 1 to 3, where magnesium hydroxide not containing the magnesium hydroxide particles according to the invention was used. The compositions obtained in Comparative Examples 1 and 3 were unsatisfactory in acid resistance, while those obtained in Comparative Examples 1, 2 and 3 were unsatisfactory in flowability. As for Comparative Examples 4 to 8, where no magnesium hydroxide was used, the composition with no flame retardant added obtained in Comparative Example 4 and the composition only of zinc oxide obtained in Comparative Example 5 were lower in flame resistance and could not satisfy the requirements of UL-94 V-0. In addition, the compositions obtained in Comparative Examples 6 and 7, where only a phosphorus-based flame retardant was used, were unsatisfactory in moisture resistance. The composition of Comparative Example 8 employing a brominated flame retardant or an antimony-based flame retardant was lower in high-temperature storage characteristics.

In contrast, the compositions obtained Examples 1 to 17 that contain all of the components (A) to (C) of the present invention satisfied the requirements of UL-94 V-0 and were superior in flame resistance, and also in acid resistance, flowability and moldability. Further, the compositions obtained in Examples 1 to 14, 16, and 17 were superior in reflow resistance, and those in Examples 1 to 17 were also superior in reliability, for example moisture resistance and high-temperature storage characteristics.

### INDUSTRIAL APPLICABILITY

The encapsulated epoxy resin composition according to the present invention gives products such as electronic component devices superior in flame resistance and also in reliability such as moldability, reflow resistance, moisture resistance and high temperature storage characteristics, and thus, has a significant industrial value.

1. An encapsulated epoxy resin composition containing an epoxy resin (A), a hardening agent (B), and magnesium hydroxide (C), the magnesium hydroxide (C) comprising magnesium hydroxide particles with its crystal appearance in a hexagonal column shape having two hexagonal top and bottom base faces in parallel with each other and six peripheral prism faces formed between the base faces and having a length in the c-axis direction of 1.5×10⁻⁶ to 6.0×10⁻⁶ m.

2. The encapsulated epoxy resin composition according to claim 1, wherein the magnesium hydroxide particles include those having a volume of 8.0×10¹⁸ to 600×10¹⁸ m³.

3. The encapsulated epoxy resin composition according to claim 1, wherein the magnesium hydroxide particles include those obtained by hydration of magnesium oxide having a crystallite diameter of 50×10⁻⁹ m or more.

4. The encapsulated epoxy resin composition according to claim 1, wherein the magnesium hydroxide (C) includes a magnesium hydroxide particle mixture comprising
the magnesium hydroxide particle and
at least one of magnesium hydroxide particles having a volume of 8.0×10⁻¹⁸ to 600×10⁻¹⁸ m³ and magnesium hydroxide particles obtained by hydration of magnesium oxide having a crystallite diameter of 50×10⁻⁹ m or more.

5. An encapsulated epoxy resin composition containing an epoxy resin (A), a hardening agent (B), and magnesium hydroxide (C), the magnesium hydroxide (C) comprising magnesium hydroxide particles prepared by a production method including a step of obtaining magnesium oxide powder by pulverizing a magnesium oxide raw material having a crystallite diameter of 50×10⁻⁹ m or more and sieving the resulting powder, a step of adding the powder into an organic acid-containing hot water at 100° C. or lower, a step of allowing hydration reaction of the magnesium oxide under high-shear agitation, and a step of filtering, water-washing, and drying the resulting solid matter.

6. The encapsulated epoxy resin composition according to claim 1, wherein the magnesium hydroxide (C) is contained in an amount of 5 to 300 parts by mass with respect to 100 parts by mass of the epoxy resin (A).

7. The encapsulated epoxy resin composition according to claim 1, further comprising a metal oxide (D).

8. The encapsulated epoxy resin composition according to claim 7, wherein the metal oxide (D) is an oxide selected from oxides of typical and transition metal elements.

9. The encapsulated epoxy resin composition according to claim 8, wherein the metal oxide (D) is at least one compound selected from oxides of zinc, magnesium, copper, iron, molybdenum, tungsten, zirconium, manganese and calcium.

10. The encapsulated epoxy resin composition according to claim 1, wherein the epoxy resin (A) include at least one resin of biphenyl-based, bisphenol F-based, stilbene-based, sulfur atom-containing, novolak-based, dicyclopentadiene-based, naphthalene-based, triphenylmethane-based, biphenylene-based and naphthol-aralkyl-based epoxy resins.

11. The encapsulated epoxy resin composition according to claim 10, wherein the sulfur atom-containing epoxy resin is a compound represented by the following General Formula (I): 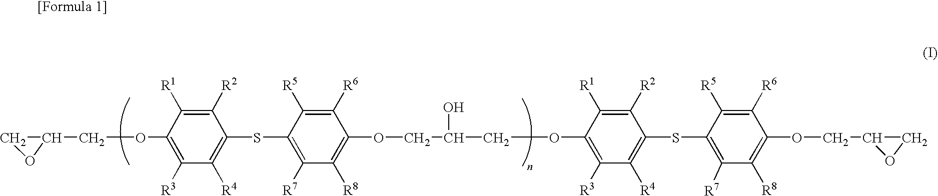
(in Formula (I), R¹ to R⁸ each represent a group selected from a hydrogen atom, substituted or unsubstituted monovalent hydrocarbon groups having 1 to 10 carbon atoms, substituted or unsubstituted alkyl groups having 1 to 10 carbon atoms and substituted or unsubstituted alkoxyl groups having 1 to 10 carbon atoms and may be the same as or different from each other; and n is an integer of 0 to 3).

12. The encapsulated epoxy resin composition according to claim 1, wherein the hardening agent (B) includes at least one of biphenyl-based, aralkyl-based, dicyclopentadiene-based, triphenylmethane-based and novolak-based phenol resins.

13. The encapsulated epoxy resin composition according to claim 1, further comprising an accelerator (E).

14. The encapsulated epoxy resin composition according to claim 13, wherein the accelerator (E) includes an adduct of a phosphine compound and a quinone compound.

15. The encapsulated epoxy resin composition according to claim 14, wherein the accelerator (E) includes an adduct of a phosphine compound having at least one alkyl group bound to the phosphorus atom and a quinone compound.

16. The encapsulated epoxy resin composition according to claim 1, further comprising a coupling agent (F).

17. The encapsulated epoxy resin composition according to claim 16, wherein the coupling agent (F) includes a secondary amino group-containing silane-coupling agent.

18. The encapsulated epoxy resin composition according to claim 17, wherein the secondary amino group-containing silane-coupling agent includes a compound represented by the following General Formula (II): 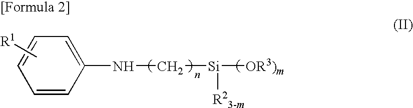
(in Formula (II), R¹ represents a group selected from a hydrogen atom, alkyl groups having 1 to 6 carbon atoms and alkoxyl groups having 1 to 2 carbon atoms; R² represents a group selected from alkyl groups having 1 to 6 carbon atoms and a phenyl group; R³ represents a methyl or ethyl group; n is an integer of 1 to 6; and m is an integer of 1 to 3).

19. The encapsulated epoxy resin composition according to claim 1, further comprising a compound having a phosphorus atom (G).

20. The encapsulated epoxy resin composition according to claim 19, wherein the compound having a phosphorus atom (G) includes a phosphoric ester compound.

21. The encapsulated epoxy resin composition according to claim 20, wherein the phosphoric ester compound includes a compound represented by the following General Formula (III): 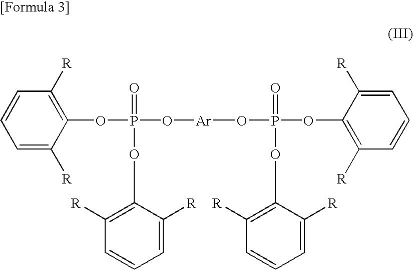
(in Formula (III), eight groups R each represent an alkyl group having 1 to 4 carbon atoms and may be the same as or different from each other; and Ar represents an aromatic ring).

22. The encapsulated epoxy resin composition according to claim 19, wherein the compound having a phosphorus atom (G) includes phosphine oxide that includes a phosphine compound represented by the following General Formula (IV): 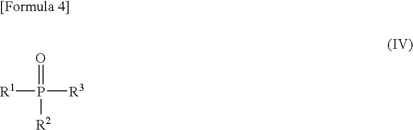
(in General Formula (IV), R¹, R² and R³ each represent a substituted or unsubstituted alkyl, aryl or aralkyl group having 1 to 10 carbon atoms or a hydrogen atom and may be the same as or different from each other; but all of them are not hydrogen atoms).

23. The encapsulated epoxy resin composition according to claim 1, further comprising at least one of a linear polyethylene oxide (H) having a weight-average molecular weight of 4,000 or more and a compound (I) of a copolymer of an α-olefin having 5 to 30 carbon atoms and maleic anhydride esterified with a monovalent alcohol having 5 to 25 carbon atoms.

24. The encapsulated epoxy resin composition according to claim 23, wherein at least one of the components (H) and (I) is premixed with part or all of the component (A).

25. The encapsulated epoxy resin composition according to claim 1, further comprising an inorganic filler (J).

26. The encapsulated epoxy resin composition according to claim 25, wherein the total content of the magnesium hydroxide (C) and the inorganic filler (J) is 60 to 95 mass % with respect to the encapsulated epoxy resin composition.

27. An electronic component device, comprising an element sealed with the encapsulated epoxy resin composition according to claim 1.

28. The encapsulated epoxy resin composition according to claim 5, wherein the magnesium hydroxide (C) is contained in an amount of 5 to 300 parts by mass with respect to 100 parts by mass of the epoxy resin (A).

29. The encapsulated epoxy resin composition according to claim 5, further comprising a metal oxide (D).

30. The encapsulated epoxy resin composition according to claim 5, further comprising an accelerator (E).

31. The encapsulated epoxy resin composition according to claim 5, further comprising a coupling agent (F).

32. The encapsulated epoxy resin composition according to claim 5, further comprising a compound having a phosphorus atom (G).

33. The encapsulated epoxy resin composition according to claim 5, further comprising at least one of a linear polyethylene oxide (H) having a weight-average molecular weight of 4,000 or more and a compound (I) of a copolymer of an α-olefin having 5 to 30 carbon atoms and maleic anhydride esterified with a monovalent alcohol having 5 to 25 carbon atoms.

34. The encapsulated epoxy resin composition according to claim 5, further comprising an inorganic filler (J).

35. An electronic component device, comprising an element sealed with the encapsulated epoxy resin composition according to claim 5.
